(19) United States
(12) Patent Application Publication
(10) Pub. No.: US 2012/0150703 A1
(43) Pub. Date: Jun. 14, 2012

(54) User as part of supply chain

(75) Inventors: Christian L. Belady, Mercer Island, WA (US); Rob Bernard, Redmond, WA (US); Angel Sarmento Calvo, Redmond, WA (US); Larry Cochrane, Redmond, WA (US); Jason Garms, Redmond, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Jennifer Mame Pollard, Redmond, WA (US); John D. Rinaldo, JR., Bellevue, WA (US); Clarence T. Tegreene, Bellevue, WA (US); Rene A. Vega, Scotts Valley, CA (US); Lowell L. Wood, JR., Bellevue, WA (US); Feng Zhao, Redmond, WA (US)

(73) Assignee: Elwha LLC, a limited liability corporation of the State of Delaware

(21) Appl. No.: 13/135,683

(22) Filed: Jul. 12, 2011

Related U.S. Application Data
(63) Continuation-in-part of application No. 12/928,638, filed on Dec. 14, 2010.
Application No. 12/928,638 is a continuation-in-part of application No. 13/135,674, filed on Jul. 12, 2011.

(51) Int. Cl. G06Q 99/00; G06Q 50/28; G06Q 30/04

(52) U.S. Cl. 705/30; 705/317; 705/308

(57) ABSTRACT

A method for determining an ecological impact score may include, but is not limited to: determining an ecological-impact score for acquiring a product, the ecological-impact score generated from at least information that quantifies ecological impact caused by at least a portion of a supply chain used to transport the product; and sending the ecological-impact score to a computing device.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/928,638, entitled LIFECYCLE IMPACT INDICATORS, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed 14 Dec. 2010, which is currently co-pending or is an application of which a currently co-pending application is entitled to the benefit of the filing date.

For purposes of the USPTO extra-statutory requirements, the present application constitutes a continuation-in-part of the United States patent application having an attorney docket No. 0109-003-04-000000 entitled EFFICIENCY-OF-USE TECHNIQUES, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed contemporaneously herewith under Express Mail No. EM483001149US, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### SUMMARY

A method includes, but is not limited to determining an ecological-impact score for acquiring a product, the ecological-impact score generated from at least information that quantifies ecological impact caused by at least a portion of a supply chain used to transport the product; and sending the ecological-impact score to a computing device. In addition to the foregoing, other system aspects are described in the claims, drawings, and text forming a part of the present disclosure.

In one or more various aspects, related systems include but are not limited to circuitry and/or programming for effecting the herein referenced aspects; the circuitry and/or programming can be virtually any combination of hardware, software, and/or firmware configured to effect the herein-referenced method aspects depending upon the design choices of the system designer.

A method includes, but is not limited to processing information to obtain an ecological-impact score for acquiring a product, the ecological-impact score generated from at least information that quantifies ecological impact caused by at least a portion of a supply chain used to transport the product; and displaying the ecological-impact score. In addition to the foregoing, other system aspects are described in the claims, drawings, and text forming a part of the present disclosure.

In one or more various aspects, related systems include but are not limited to circuitry and/or programming for effecting the herein referenced aspects; the circuitry and/or programming can be virtually any combination of hardware, software, and/or firmware configured to effect the herein-referenced method aspects depending upon the design choices of the system designer.

A computer-readable storage medium product includes, but is not limited to instructions for determining an ecological-impact score for acquiring a product, the ecological-impact score generated from at least information that quantifies ecological impact caused by at least a portion of a supply chain used to transport the product; and instructions for sending the ecological-impact score to a computing device. In addition to the foregoing, other computer-readable storage medium aspects are described in the claims, drawings, and text forming a part of the present disclosure.

A computer-readable storage medium product includes, but is not limited to instructions for processing information to obtain an ecological-impact score for acquiring a product, the ecological-impact score generated from at least information that quantifies ecological impact caused by at least a portion of a supply chain used to transport the product; and instructions for displaying the ecological-impact score. In addition to the foregoing, other system aspects are described in the claims, drawings, and text forming a part of the present disclosure.

A system includes, but is not limited to circuitry for determining an ecological-impact score for acquiring a product, the ecological-impact score generated from at least information that quantifies ecological impact caused by at least a portion of a supply chain used to transport the product; and instructions for sending the ecological-impact score to a computing device. In addition to the foregoing, other system aspects are described in the claims, drawings, and text forming a part of the present disclosure.

A system includes, but is not limited to circuitry for processing information to obtain an ecological-impact score for acquiring a product, the ecological-impact score generated from at least information that quantifies ecological impact caused by at least a portion of a supply chain used to transport the product; and circuitry for displaying the ecological-impact score. In addition to the foregoing, other system aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a high-level block diagram of an operational environment.

FIG. 2 shows an exemplary high-level block diagram of an exemplary system.

FIG. 3 shows a high-level block diagram of a product.

FIG. 4 shows a high-level block diagram of a device.

FIG. 5 shows an operational procedure.

FIG. 6A shows an alternative embodiment of the operational procedure of FIG. 5.

FIG. 6B shows an alternative embodiment of the operational procedure of FIG. 5.

FIG. 7A shows an alternative embodiment of the operational procedure of FIG. 6B.

FIG. 7B shows an alternative embodiment of the operational procedure of FIG. 6B.

FIG. 8 shows an alternative embodiment of the operational procedure of FIG. 7B.

FIG. 9 shows an alternative embodiment of the operational procedure of FIG. 6B.

FIG. 10 shows operational procedure.

FIG. 11 shows an alternative embodiment of the operational procedure of FIG. 10.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The consumption of rare materials and the ecological impact caused by human behavior are becoming serious problems for the Earth. For example, some experts estimate that our use of the ecosystem to obtain food, timber, energy, exceeds the planet's ability to provide. As if the scarcity of resources was not enough of a problem, human behavior is also causing increasing amounts of greenhouse gasses to be emitted into the atmosphere. Certain greenhouse gasses, such as carbon monoxide, sulfur dioxide, chlorofluorocarbons (CFCs) and nitrogen oxides are generated in part by manufacturing, using, and disposing of products. The general consensus is that these greenhouse gases cause harm to the environment. For example, according to the 2007 Fourth Assessment Report by the Intergovernmental Panel on Climate Change (IPCC), greenhouse gases have caused the global surface temperature increased 0.74±0.18C (1.33±0.32F) during the 20th century. Climate models project that the temperature will increase another 1.1 to 6.4C (2.0 to 11.5F) during the 21st century. It is likely that this increase in temperature is a significant problem for living creatures. For example, the living planet index, which is an indicator of the state of global biological diversity, shows that between the period of 1970 and 2003 biodiversity fell 30 percent.

The demand for products is causing significant damage to the environment and most people are complacent. People may indicate that they care about the environment; however, it seems that some, if not most people, do not act in an environment friendly, even if they are aware of how their actions truly affect the environment. One reason for this may be that impact is too abstract to appreciate. For example, a person may recognize that driving a car causes harm to the environment; however, the person may not appreciate how much harm it causes because the person is not penalized nor does the person have to perceive any link between their behavior and the damage caused.

Accordingly, robust methods, systems, and computer program products are provided to, among other things; bring about an operational system wherein users can perceive how product acquisition and consumption behavior affects the environment. As such, in an exemplary embodiment, the ecological impact caused by at least a part of a “supply chain,” e.g., a system of organizations, people, technology, resources, etc., used to transport a product from a vendor (an entity such as a company that provides goods) to an end user can be quantified and used to generate an ecological-impact score. For example, ecological impact data associated with trucks, planes, ships, buildings, etc., can be quantified and a score such as the amount CO₂e that can be attributed to a product can be determined. Alternatively, instead of the amount of generated CO₂e, a number, e.g., 1 to 10, a value on a scale (awful, bad, neutral, good, or exceptional) and/or a letter grade (A, B, C, D, or F) can be determined and communicated to an acquiring user, e.g., a person that purchased the product.

In the same or another embodiment, ecological-impact data from a variety of different sources can be quantified and used to determine an ecological-impact score. As such, in this alternative embodiment, the other sources could be converted to CO₂e and a number, e.g., 1 to 10, a value on a scale (awful, bad, neutral, good, or exceptional) and/or a letter grade (A, B, C, D, or F) can be determined and communicated to an acquiring user, e.g., a person that purchased the product.

In yet another embodiment, a variety of different sources can be quantified and used to determine an ecological-impact score such as a number, e.g., 1 to 10, a value on a scale (awful, bad, neutral, good, or exceptional) and/or a letter grade (A, B, C, D, or F). In this example, data may not be first converted to CO₂e.

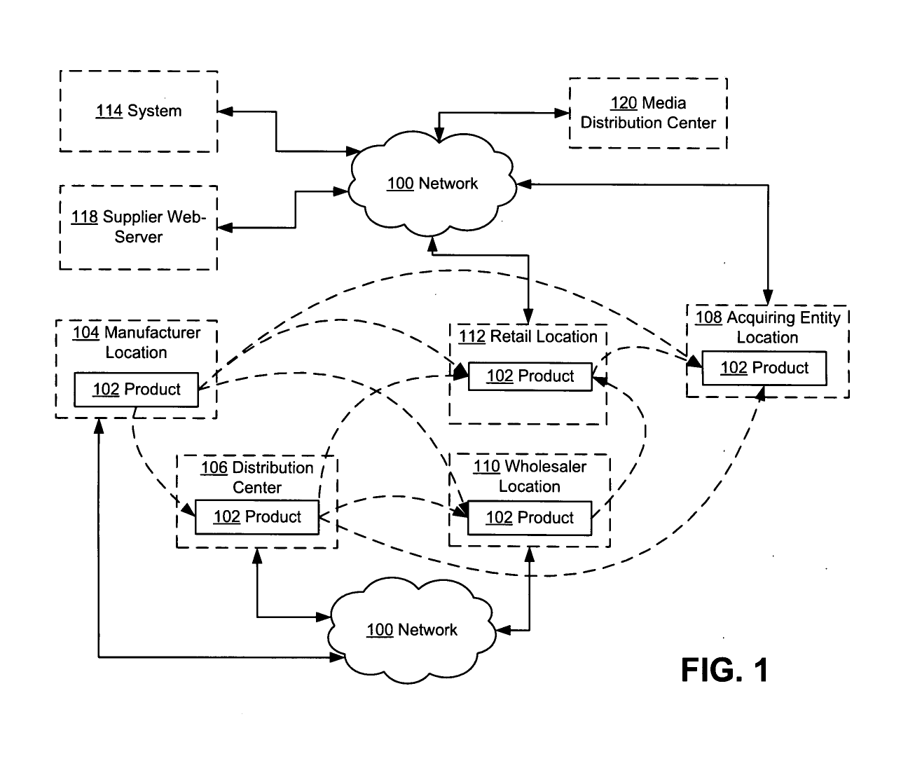

Referring now to FIG. 1, it illustrates a high-level block diagram of an exemplary operational environment that can be used to describe embodiments of the present disclosure. The curved-dashed arrows represent the infrastructure, e.g., planes, ships, trucks, warehouses, people, etc., used to move product 102 to different locations within a supply chain. The block-elements indicated in dashed lines are indicative of the fact that they are considered optional.

Each element within FIG. 1 can be interconnected via network 100, which may be the Internet. Each element can connect to network 100 using an access method such as, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wireless or wired networks.

At a high level of abstraction, the curved arrows within FIG. 1 illustrate the infrastructure within a supply chain used to transport a product from a place associated with a manufacturer, e.g., manufacturer location 104, which could be a factory, warehouse, etc., to an acquiring entity location 108, which could be a place where product 102 is used, e.g., an office, a household, etc. Put another way, each curved arrow could represent the infrastructure used by one or more shipping service, e.g., FedEx®, United States Parcel Service®, UPS®, DHS®, etc., to move a product from one point to another. In a specific example, the dashed arrow from manufacturer location 104 to acquiring entity location 108 could represent the shipping infrastructure used by FedEx® to ship a product. As such, the curved arrow could represent multiple transfer points and multiple shipping methods, e.g., truck, ship, plane, etc. In a specific example, the arrow from manufacturing location 104 to acquiring entity location 108 could represent that a product is picked up at a warehouse operated by a manufacturing entity; taken to a FedEx® warehouse; shipped, from the warehouse by air to a warehouse for a geographic region such as the Seattle metro region; and transported, by truck from the warehouse to a user's home.

A particular product may be associated with different supply chains. For example, different shipping services may use different infrastructure to move a product and different companies may impose different shipping requirements on the shipping carriers they use, and even dictate how a product is manufactured. Alternatively, a company may only control a portion of a supply chain for a product. For example, a company may own or control one or more retail locations. In this example, the company may negotiate a contract with a product manufacturer to purchase products and the manufacturer may ship them according to the terms of the contract. Alternatively, the manufacturer or the company may select a shipping-method to ship the product.

In an exemplary embodiment, ecological impact caused by the infrastructure used to effectuate a “leg” or a portion of a leg can quantified and used to determine an ecological-impact score. As such, an ecological-impact score can reflect how harmful at least a portion of a supply chain is to the environment. In the same, or another embodiment, an ecological-impact score can reflect harm caused by the entire supply chain for a product. For example, ecological-impact due to making; shipping; using; and disposing the product could can quantified and used to determine an ecological-impact score

In an exemplary embodiment, the ecological impact caused by the infrastructure can be quantified and the percentage of the ecological impact that can be attributed to product 102 can be used to determine an ecological-impact score. For example, if product 102 takes up 10% of the space on a truck, in this embodiment 10% of the ecological impact caused by the truck could be used to determine an ecological-impact score for product 102. As such, the ecological-impact score can be determined from the ecological impact caused by the transportation method or methods used to physically move product 102, the ecological impact caused by maintaining one or more intermediary warehouses, and/or the ecological impact caused by the route taken by a transportation method before it arrives at an acquiring entity's location. The shipping decisions made by an acquiring entity can also be considered part of the supply chain. As such, in an embodiment, ecological impact caused by a method of transportation the user selects can be used to generate an ecological-impact score.

In an exemplary embodiment, the ecological impact caused by a supply chain can be quantified and used by system 114 to generating an ecological-impact score. Briefly, system 114 can include one or more computer systems having processors, memory, operating system software, network adaptors, etc., can be used to compute ecological-impact scores. System 114 could be controlled by a company such as Mal-Mart®, FedEx®, etc., and used to generate ecological-impact scores for at least a portion of the supply chain it uses. Alternatively, system 114 could be maintained by a separate entity. As such, system 114 could be maintained by any number of individuals or organizations that wish to compute scores that reflect how harmful supply chains are to the environment. In a specific example, system 114 could be maintained by the government. In this exemplary embodiment, the government can require that shipping services provide data that describes how much ecological harm transportation methods cause and the government can compute efficiency-of-use scores. In another exemplary embodiment, system 114 can be controlled by a Green Organization, e.g., an entity that stands for reducing the impact humans have on the environment. In this example, enrollment with system 114 may be voluntary. In yet another exemplary embodiment, system 114 can be controlled by a shipping company such as FedEx®. In this case, the shipping company may provide ecological-impact scores as a value-add to differentiate themselves from other shipping companies.

In addition to the foregoing, FIG. 1 additionally shows supplier web-server 118. For example, supplier web-server 118 could be controlled by a company that offers products online such as Wal-Mart®, Amazon.com®, Target®, etc. In this example, supplier web-server 118 may use the ecological-impact scores determined by system 114. For example, system 114 could expose an interface that supplier web-server 118 can use to retrieve ecological-impact scores. Alternatively, an agent of system 114 could disseminate ecological-impact scores via telephone calls, faxes, emails, etc., to an agent of supplier web-server 118, who could then add the ecological-impact scores to product descriptions of products. In the configuration where system 114 exists as a separate entity, system 114 may be used by a plurality of suppliers, each of which may sell the same or different products using the same or different transportation infrastructure to physically move product 102 from one location to another.

Media distribution center 120 is also illustrated in FIG. 1. Media distribution center 120 can be maintained by the same organization that maintains server 114 or a separate entity. Generally, media distribution center 120 can be configured to receive; store; and/or disseminate information gathered by system 114. For example, media distribution center 120 can be configured to include a web server, email server, short message service (“SMS”) server, television station, etc. In a specific example, media distribution center 120 can receive, store, and/or disseminate information such as efficiency-of-use scores, ecological-impact scores, etc.

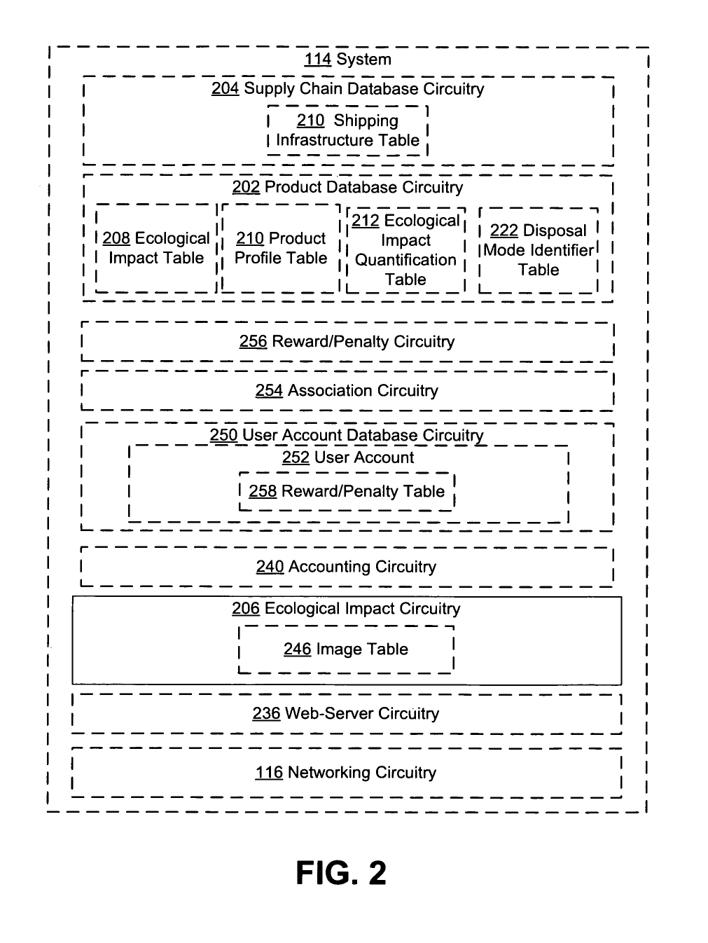

Referring now to FIG. 2, it illustrates a high-level block diagram of system 114. Briefly, FIG. 2 illustrates various circuitry, i.e., hardware and/or a combination of hardware and software/firmware, used to illustrate concepts and the disclosure is not limited to the illustrated configuration. Product database circuitry 202 can include one or more collections of information and this information can be used to generate ecological-impact quantifications for products, e.g., values such as 5 impact points or abstract values such as “good,” “average,” or “bad,” for at least one stage of a product's lifecycle, e.g., its production phase, use phase, and/or disposal phase, that can be stored ecological impact quantification table 208.

One type of data that can be used to generate ecological impact quantifications is rare earth materials data. For example, rare earth materials data can include a list of the materials that are used up and/or the materials that a product is made from when it is manufactured. In at least one exemplary embodiment, data that identifies the rare materials that are in product 102 (and other products) and/or the rare materials that were consumed in the process of making product 102 can be used to generate one or more ecological-impact quantifications. For example, a breakdown of the components in product 102 can be obtained and the amount of rare-earth materials and/or rare materials that were used to create product 102 can be derived.

Rare materials can include rare-earth materials and/or materials that are simply scarce. For example, the International Union of Pure and Applied Chemistry has established a collection of chemical elements from the periodic table that are considered “rare-earths.” For the most part, these elements are not rare in the sense that they are not abundant, but that they are difficult to purify from their oxides. Rare-earth elements are essential components in modern electronics and demand is growing. For example, Cerium oxide, the lowest value rare earth, jumped 930 percent from 2007 to over $35 per kilogram in 2010. The rare-earth elements are Lanthanum (which can be used to create high refractive index glass, camera lenses, battery-electrodes), Cerium, Praseodymium, Neodymium, Promethium (which can be used to create nuclear batteries), Samarium, Europium, Gadolinium (which can be used to create computer memory), Terbium, Dysprosium, Holmium, Erbium (which can be used to produce vanadium steel), Thulium, Ytterbium, Lutetium, Actinium, Thorium, Protactinium, Uranium, Neptunium, Plutonium, Americium, Curium, Berkelium, Californium, Einsteinium, Fermium, Mendelevium, Nobelium, and Lawrencium.

Another type of data that can be used to generate ecological impact quantifications is information that describes the hazardous materials that are a byproduct of making product 102 and/or the hazardous materials that are contained within product 102. Hazardous waste can include waste that poses a substantial or potential threat to public health and/or the environment. The list of hazardous substances tracked and used to generate ecological impact quantifications may vary a bit from one country to another and can include, but is not limited to, substances that may explode when exposed to a flame or when shocked, substances that are highly flammable, etc., and/or substances that are toxic, corrosive, infectious, carcinogenic, etc.

Another type of data that can be used to generate ecological impact quantifications is information that describes the ground pollutants that are a byproduct of making product 102 and/or the hazardous materials that are contained within product 102. Generally, ground pollutant data can include information such as the estimated amount of pollutants that are emitted when manufacturing product 102 (other than hazardous waste) and/or the estimated amount of ground pollution generated by disposing of a product according to different disposal modes. In an exemplary embodiment, the ground pollutants tracked can include, but are not limited to, heavy metals, chlorinated hydrocarbons, led, zinc, benzene, etc. This type of typically enters the environment via landfills.

Another type of data that can be used to generate ecological impact quantifications is information that describes the greenhouse gases (i.e., normalized greenhouse gases expressed as carbon dioxide equivalent or CO₂e) that are associated with product 102. Greenhouse gasses are emitted in almost every stage of a product's lifecycle and in an exemplary embodiment, the amount of normalized greenhouse gasses that can be attributed to the production, use, and/or disposal of a product can be collected and used to generate one or more ecological-impact quantifications. For example, the amount of electricity used to manufacture product 102 can be determined. The source of the energy can be determined from the power plant and the amount of CO₂e emissions generated by the power plant in order to produce the power used to acquire raw materials and manufacture a product can be captured.

The amount of CO₂e generated from power plants can be estimated from information obtained from the energy grid. For example, the power company that manages the grid can provide information that identifies the source of the energy, e.g., hydro-power, natural gas, coal, etc., and the CO₂e emissions with each energy source can be calculated as well as the percentage of energy generated from each source.

The list of gasses can include the following and an amount of each gas can be multiplied by a scalar value, shown in parenthesis, in order to convert the gases (in metric tons) to CO₂e: carbon dioxide (1), methane (21), nitrous oxide (310), perfluorocarbons (2,300), hydrofluorocarbons (12,000), and sulfur hexafluoride (23,900). This shows that one million metric tons of methane and nitrous oxide is equivalent to emissions of 21 and 310 million metric tons of carbon dioxide. In an exemplary embodiment, information provided from the Environment Protection Agency (the “EPA”) can be used to estimate the amount of CO₂e associated with products. This information can be found in the report entitled “Inventory of U.S. Greenhouse Gas Emissions and Sinks: 1990-2005” and the EPA's report entitled “Solid Waste Management and Greenhouse Gases: A lifecycle Assessment of Emissions and Sinks,” 3^{rd} Edition September 2006, both of which are herein incorporated in their entirety.

In exemplary embodiments, some or all of the above mentioned data can be used to generate one or more ecological-impact quantifications for one or more products. For example, an ecological-impact quantification could be based at least in part on the amount of rare-materials associated with a product, the amount of hazardous waste associated the product, the amount of ground pollution associated with the product, and/or the amount of CO₂e associated with the product. For example, 60 kilograms of CO₂e may be emitted during the manufacturing process for a cellular phone. In an exemplary embodiment, this amount of CO₂e can be quantized along with the amount of rare materials in the cellular phone, the amount of hazardous waste and ground pollution created to make the cellular phone. The quantifications can then be combined, e.g., added, multiplied, etc., in order to create an ecological-impact quantification.

Each ecological-impact quantification can be categorized into a group for a different stage of a product's lifecycle. For example, ecological-impact associated with a production phase, a use-phase quantification, and a disposal phase quantification can be stored in ecological impact quantification table 212. In an exemplary embodiment, a single product may be associated with an ecological-impact quantification that is based on the potential harm to the environment caused by producing the product, the potential harm caused by using the product, and/or the potential harm that could be caused by the different ways of disposing of the product. In another exemplary embodiment, a single ecological-impact quantification can be generated that shows the cumulative ecological-impact caused by the product, e.g., the ecological-impact quantification could be the sum of all of the aforementioned ecological-impact quantifications for the different phases of the product's lifecycle.

In a specific example, production ecological-impact quantifications can be based on the amount of rare-materials in a product or the amount of rare-materials that were consumed to create a product. In this example, the quantification process can use the price of the rare-material and/or the amount of the rare-material in product 102 when generating a ecological-impact quantification. For example, a kilogram of a less valuable rare-earth material such as cerium oxide could be mapped to a materials-score of 1 where as a kilogram of praseodymium (a more expensive rare-earth) can be mapped to a ecological-impact quantification of 9. The materials ecological-impact quantification can optionally be combined with other ecological-impact quantifications to create a production ecological-impact quantification.

In addition to rare-materials, a production ecological-impact quantification can be based on the amount and type of hazardous waste that was created to produce a product. For example, a high amount of a dangerous type of hazardous waste can be mapped to a high ecological-impact quantification. This ecological-impact quantification can optionally be combined with other ecological-impact quantifications to create production ecological-impact quantification.

In yet another embodiment, a production ecological-impact quantification can be based on the amount of CO₂e generated to create a product. For example, CO₂e is typically emitted during this phase in order to generate the energy to transport raw/manufactured materials to a product manufacturer and the energy needed to assemble the materials into the product. In this example, the amount of CO₂e generated to build one product can be estimated and mapped to a CO₂e-based ecological-impact quantification. For example, low amounts of CO₂e can be mapped to low CO₂e-based ecological-impact quantifications and high amounts of CO₂e can be mapped to high CO₂e-based ecological-impact quantifications. A CO₂e-based ecological-impact quantification can then be combined with one or more other ecological-impact quantifications to obtain a production phase ecological-impact quantifications.

CO₂e emissions associated with acquiring raw materials and manufacturing product 102 can include energy consumed to obtain raw materials, manufacturer products, manage the corporation, and dispose of waste. In general, the majority of energy used for these activities is derived from fossil fuels burned to operate mining equipment, fuel blast furnaces, etc., and to generate electricity to power machines used during the manufacturing stage.

Use phase ecological-impact quantifications can reflect the potential harm caused to the environment due to the transporting, storing, and actually using a product. The majority of the ecological impact in this phase can be attributed to CO₂e emissions associated with the power used by a product, and/or the CO₂e emitted by product as it operates, e.g., a vehicle. Food services products may require refrigeration, which requires electricity that is associated with CO₂e emissions. Most cold storage facilities operate at a wide range of temperatures. In an exemplary embodiment, an average temperature can be estimated along with an average size of a storage facility and the average amount of energy used to refrigerate a product, which may be a six pack of beer. This information along with the volume of the product can be used to estimate the CO₂e emissions caused by storing the product in a refrigerated facility and the CO₂e emissions can be used to generate a use phase ecological-impact quantification.

Similar to the aforementioned ecological-impact quantification associated with transportation and/or storage, an ecological-impact quantification associated with operating the product can be calculated from mostly the CO₂e emitted in order to generate the power for a product and/or the CO₂e emitted by the product as it is running. For example, any product that consumes electricity most likely causes harm (even if it is indirect harm) to the environment due to the fact that the power it consumes likely comes from a source of energy that generates CO₂e.

When a product is used up, broken, etc., it can be disposed of. In an exemplary embodiment, disposal phase ecological-impact quantifications can be based on one or more of the amount of rare materials lost due to disposing of a product, the amount of CO₂e emitted when disposing of a product (either from the product or from the equipment used to dispose of the product), the amount of hazardous waste that product emits during disposal, the amount of ground pollution generated by disposing of a product, etc. In an exemplary embodiment, each disposal phase ecological-impact quantification can be associated with a disposal-mode-identifier. The disposal-mode-identifier can be associated with information that describes how to dispose of the product according to a disposal mode. For example, a recycling disposal-mode-identifier could be associated with text that provides the address of a recycling facility or a map to the recycling facility. In another specific example, an incineration disposal-mode identifier can include audio describing which type of disposal receptacle, e.g., trash can, dumpster, etc., the product should be placed in to have it incinerated.

Since a product can be disposed of in different ways, each product can be associated with multiple disposal ecological-impact quantifications. An exemplary, non-exhaustive list of disposal modes can include reselling (and/or donating, trading, etc), recycling, composting, incinerating, landfilling, etc. Thus, in an exemplary embodiment a product can be associated with one or more ecological-impact quantification for each disposal mode that is available to a product. For example, a product such as a mp3 player may have available modes that include a reselling mode, a recycling mode, and a landfilling mode.

In an exemplary embodiment, a product can be associated with a resell disposal mode. In this exemplary embodiment, the ecological-impact quantification associated with reselling the product can be based on an estimated amount of CO₂e used to transport the product from one user to the next user. In some instances, the CO₂e may be negligible.

In an exemplary embodiment, a product can be associated with a ecological-impact quantification associated with a recycling disposal mode. In an exemplary embodiment, the ecological-impact quantification for recycling can be based on, for example, the amount of CO₂e associated with generating the power used to disassemble the product, the amount of rare materials that are lost during the recycling process, etc. Since recycling a product involves disassembling the product and using parts of it in other products, products made from a recycled product may have lower production phase ecological-impact quantifications than similar products made from virgin materials.

Composting is another disposal mode and a ecological-impact quantification for composting a product can be generated. Composting is the process of disposing of organic material by way of aerobic decomposition. For example, composing may result in CH₄ emissions from anaerobic decomposition and N₂0 may be released by the soil after compost is applied to the ground, however these emissions are essentially zero. Composing has an additional benefit of capturing carbon and can be used to enrich soils. Disposal by sequestration is another technique used to reduce the amount of carbon that escapes into the environment. The EPA estimates composting/sequestering reduces the amount of CO₂e emitted by 0.05 metric tons of CO₂e per ton of compost. In an exemplary embodiment, the information can be used to generate a composing CO₂e-based ecological-impact quantification for products that can be composted. In some instances, this ecological-impact quantification could reduce the harm caused to the planet.

Another disposal mode is incineration. Incineration involves the combustion of organic substances within waste materials thereby converting the waste into ash, heat, and flue gases, which may contain significant amounts of particulate matter, heavy metals, dioxins, furans, sulfur dioxide, and hydrochloric acid, and/or CO₂. Municipal solid waste (“MSW”) contains approximately the same mass fraction of carbon as CO₂ itself (27%), so incineration of 1 ton of MSW produces approximately 1 ton of CO₂. In an exemplary embodiment, the amount of CO₂e emitted by incineration, the amount of CO₂e generated in order to power the incineration facility, the amount of hazardous waste generated, etc., can be gathered; and used to create a ecological-impact quantification for disposing of a product according to an incineration mode of disposal. Similar to incineration, waste can evaporated by storing liquids in evapo-transpiration beds or mechanical evaporation units and ecological-impact quantifications can be developed that reflect the harm to the environment caused by evaporating liquid products.

A disposal mode for a product could include sending the product to a landfill. During solid-waste landfill operations, waste collection vehicles transport the waste materials to a tipping face or working front where they unload their load. After loads are deposited, compactors or dozers can be used to spread and compact the waste on the working face and the compacted waste can be covered with soil daily.

Landfills cause a number of problems for the environment such as pollution by the contamination of groundwater and soil and the gasses released by decaying organic material. The CO₂e emissions of a landfill are mostly due to methane emissions, transportation related carbon dioxide emissions, and carbon storage resulting from landfilling organic waste and solid waste. Metals do not contain carbon and do not generate CO₂e emissions; however they could cause ground pollution. For example, salt, nitrates, led, copper, nickel, cadmium, etc., are different materials that can cause ground pollution. Plastics do not biodegrade and therefore do not emit greenhouse gases. This information can then be used to create a landfill ecological-impact quantification.

Ocean floor disposal is another disposal method. This technique involves depositing waste, e.g., radioactive waste, in ocean floor sediment. Exemplary techniques for depositing waste involve encasing the waste in concrete or in a shaft drilled into the bottom of the ocean. Ecological-impact quantifications can be created that take into account the potential-ecological harm caused by depositing waste in the ocean.

In addition to ecological impact quantifications, product database 202 can store product-use profiles in product profile table 210 that describe efficient use of a product. These profiles can be used by ecological-impact circuitry 206 to compute efficiency-of-use scores, which reflect how efficiently the user has used or is using one or more products. In the same, or another embodiment, a cumulative efficiency-of-use score can be generated and stored. Briefly, the cumulative efficiency-of-use score can be a combination of efficiency-of-use scores for different products. An efficiency-of-use score can be a numerical value, e.g., a value from 0 to 10, −100 to 100, etc. In a specific example, higher efficiency-of-use scores could reflect more inefficient use. Thus, a score of 0 in a specific embodiment where the score runs from 0 to 10 would reflect an extremely efficient use whereas a score of 10 would reflect an incredibly inefficient use of a product. In other exemplary embodiments, the efficiency-of-use score could be an abstract indicator such as “bad” or “good.” In a simple example, a product could be a light bulb and an efficiency profile could be gathered that describes how much energy it should use over a time period, e.g., a day, if it is being used efficiently. Ecological-impact circuitry 206 can then use information that describes how much energy the light bulb used over the time period as well as the use profile to generate an efficiency-of-use score.

As shown by the figure, ecological-impact circuitry 206 can be associated with one or more tables of information, which can be used in exemplary embodiments of the present disclosure to configure ecological-impact circuitry 206. Briefly, image table 246 can include images of products that can be associated with device-readable indicators. In an exemplary embodiment, products may not include device-readable indicators and ecological-impact circuitry 206 can determine indicators from images.

In the same, or another embodiment, ecological-impact circuitry 206 can be configured to generate ecological-impact scores that indicate how much harm at least a part of a supply chain caused or may cause to the environment. In an exemplary embodiment, ecological-impact circuitry 206 can use information from supply chain database circuitry 204 to execute such operations. In a configuration where system 114 is used by multiple companies, supply chain database circuitry 204 can include a table for a company and information about the shipping carrier or carriers that are used to effectuate the supply chain.

Information that describes the ecological-impact caused by the infrastructure used to effectuate each leg in a supply chain can be gathered and used to compute ecological-impact scores. In a specific example embodiment, the information may be for the leg between a manufacturing location and a retail location and may include the ecological cost, e.g., an amount of CO₂e generated, to effectuate the infrastructure. Ecological-impact circuitry 206 could determine an ecological-impact score for this leg by using the weight, size, and/or other information about product 102 and/or its packaging in conjunction with the ecological cost of the leg to generate an ecological-impact score for the product. In the instance that this score is for a part of the supply chain, it can optionally be combined with other scores that reflect the ecological-impact of other parts of the supply chain to obtain an ecological-impact score for the entire supply chain.

In a specific example, ecological-impact circuitry 206 can determine how much ecological-impact caused by the infrastructure can be attributed to a particular product and use this information to generate an ecological-impact score. For example, information such as the size and weight of product 102 as well as the size and weight of a shipping container, e.g., a cardboard box, used to ship product 102 can be captured and stored by supply chain database circuitry 204. Information such as the amount of energy needed to store product 102 at warehouse (e.g., in the instance that product 102 needs to be stored at a certain temperature) and/or how much space product 102 takes in a warehouse can be stored by supply chain database circuitry 204.

In an exemplary embodiment, some ecological-impact scores for products can be computed and persisted to storage so that they can be retrieved at a later point without computing the ecological-impact score again. In the instance that an ecological-impact score for a product is not persisted by supply chain database circuitry 204, ecological-impact circuitry 206 can compute one in response to a request.

In an exemplary embodiment, companies can access shipping infrastructure table 210 to retrieve ecological-impact scores. The companies can then attach them to product 102, e.g., the ecological-impact scores can be written to a tag attached to product 102 and/or a product package, embedded within an RFID tag, memory, and/or a barcode attached to product 102 and/or a product package. The companies could also add the ecological-impact scores to information about product 102 that is listed in a webpage for product 102.

As described in more detail in the following paragraphs, efficiency-of-use scores and/or ecological-impact scores can be used in a variety of ways. For example, in a specific exemplary embodiment, reward/penalty circuitry 256 can be configured to reward or penalize the user based on his or her score. After a user finishes using a product or while the user is using the product, an efficiency-of-use score can be computed and routed to reward/penalty circuitry 256. Reward/penalty circuitry 256 can process an efficiency-of-use score and/or an ecological-impact score and determine whether to reward or penalize the user based on the score. If the user is penalized or rewarded, information can be stored in reward/penalty information 258 table. For example, a reward stored in reward/penalty information table 258 could include an icon indicative of a trophy created by an organization committed to acting in an environmentally friendly way. In another embodiment, reward/penalty information table 258 could include a graphic indicative of a coupon, a gift certificate, information indicating free or reduced services given to user 300, etc. Similarly, reward/penalty information table 258 can include penalties associated with user account 252 based on disposal and/or product purchasing behavior. For example, a penalty could be a fee charged to user 300, a trophy with a negative association, etc. In another specific example, efficiency-of-use scores can be used to charge users based on inefficient use of products. For example, accounting circuitry 240 can be configured to charge user accounts fees based on their efficiency-of-use score or scores.

Continuing with the description of FIG. 2, association circuitry 254 can be executable instructions that upon execution by a processor can cause the processor to link specific instances of a product to a user account. Briefly, each instance of a product tracked by system 114 can be assigned a unique identifier, e.g., a device-readable indicator or a device-readable indicator plus a unique serial number, and each user that could potentially use the tracked products can be assigned a user account, which can be stored in user account database circuitry 250. When a user takes control of a product, e.g., when he or she purchases, borrows, or receives product 102, association circuitry 254 can create a relationship between information that identifies the account of a user, e.g., user account 252, and the identifier for product 102. User account 252 is illustrated, which can be associated with user 300 described in more detail in the following paragraphs (while one user account is shown, system 114 can maintain accounts for a plurality of users).

User account database circuitry 250 can be maintained by the entity that controls or uses system 114. For example, suppose system 114 is setup by a company such as Wal-Mart®, Amazon.com®, Target®, etc. In this example, user account database circuitry 250 may include user accounts for users that shop online with the company. Alternatively, user accounts can be tied into a social network where users can blog, post pictures, send message to each other, etc. In an exemplary embodiment, system 114 can include or be associated with a social networking service maintained by, for example, web-server circuitry 236. Web-server circuitry 236 can be configured to generate one or more web-pages that can be downloaded to computing devices, e.g., table personal-computers, smart phones, etc., that include logic operable to allow users to interact with each other. For example, web-server circuitry 236 can send web-pages to computing devices that allow users to blog, post pictures, etc.

Each user account, such as user account 252, can optionally include a product list, which can contain a listing of products associated with user account 252, i.e., products rented, borrowed, or products that the user owns. Each product in the list can be associated with information that describes its status, e.g., owned, borrowed, or disposed of, the disposal method selected to dispose of the product, how long the product has been associated with the user account, a unique serial number for the product (which can be used to associate specific instances of a product with a specific user), etc.

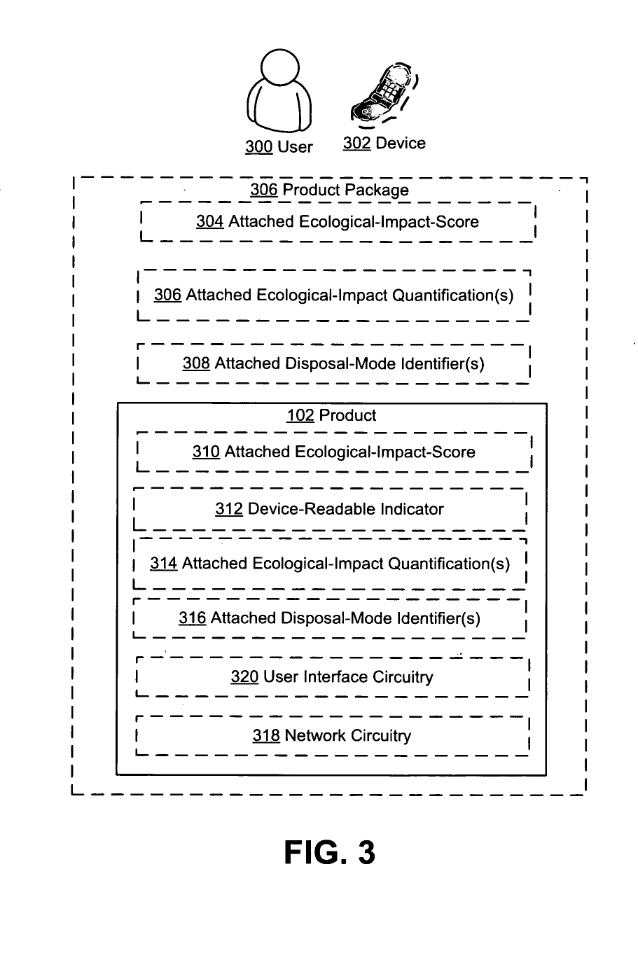

Turning now to FIG. 3, it generally illustrates an exemplary environment, which could be a retail location, a wholesaler location, an acquiring entity location, etc. As shown by the figure, product 102 is packaged in product package 306, which could be a box, plastic wrap, a plastic shell, etc. As shown by the figure, product package 306 and/or product 102 can include an ecological-impact score (304 and/or 310). For example, a company could print off an ecological-impact score that reflects the ecological impact that is caused by a portion of the supply chain used to transport product 102 and attach a sticker or some other tag to product package 306 and/or product 102. In this example, user 300 determining whether to purchase product 102 could look at the tag or sticker and get an idea of the ecological harm caused to deliver product 102 to retail location 112, wholesaler location 110, etc. In the same, or another embodiment, an ecological-impact score (304 and/or 310) can be stored in an RFID tag, a barcode, a memory, e.g., ROM, and/or etched into product package 306 and/or product 102.

In the same, or another embodiment, user 300 could use device 302 to obtain one or more ecological-impact quantifications (306 and/or 314) from product package 306 and/or product 102. For example, a barcode or RFID tag could be attached to product 102 and/or product package 306 that includes an ecological-impact score. Alternatively, the barcode or RFID tag could include a device-readable identifier, which can be submitted to system 114 to obtain an ecological-impact score.

In the same, or another embodiment, user 300 could use device 302 to obtain one or more disposal-mode identifiers (308 and/or 316) that describe a method of disposing of product package 306 and/or product 102. For example, supplier web-server 118 could print off disposal-mode identifiers (308 and/or 316) and attach a sticker or some other tag to product package 306 and/or product 102. In this example, user 300 determining whether to purchase product 102 could look at the tag or sticker and get an idea of the ecological harm caused by product 102. In the same, or another embodiment, disposal-mode identifiers (308 and/or 316) can be stored in an RFID tag, a barcode, a memory, e.g., ROM, and/or etched into product package 306 and/or product 102. In each of these examples, user 300 could use device 302 to extract disposal-mode identifiers (308 and/or 316).

Product 102 can also include network circuitry 318, which could be a network adaptor and the software instructions used to control the network adaptor. In this example, product 102 may be in communication with system 114 in order to receive one or more disposal mode identifiers, ecological-impact quantifications, and/or ecological-impact scores.

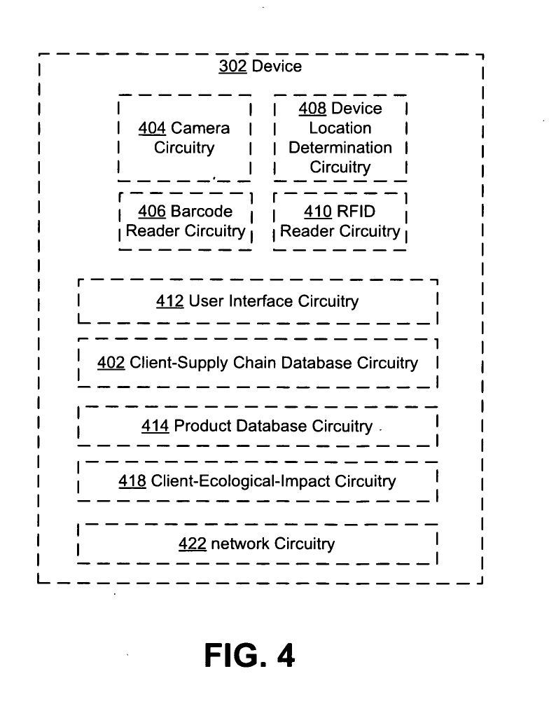

Referring to FIG. 4, it illustrates circuitry that can be integrated within device 302. Device 302 may be a computing/communication device including, for example, a laptop, a tablet computer system, a desktop PC, or a handheld device such as a cellular telephone, a smart phone, a Mobile Internet Device (MID), an Ultra Mobile Personal Computer (UMPC), a convergent device such as a personal digital assistant (PDA), and so forth. For example, device can include memory, e.g., random access memory, ROM, etc., that can contain executable instructions that can be executed by a processor. In addition, device 302 can include various integrated circuits such as GPS radios, network interface adaptors, etc., and the associated firmware that operates such devices. Device 302 can include user interface circuitry 412, which could include, but is not limited to, input components implemented by a combination of hardware and software such as a touch user interface, a keypad, a directional pad, a microphone, etc., and output components such as a screen, e.g., an liquid crystal display, a speaker, etc.

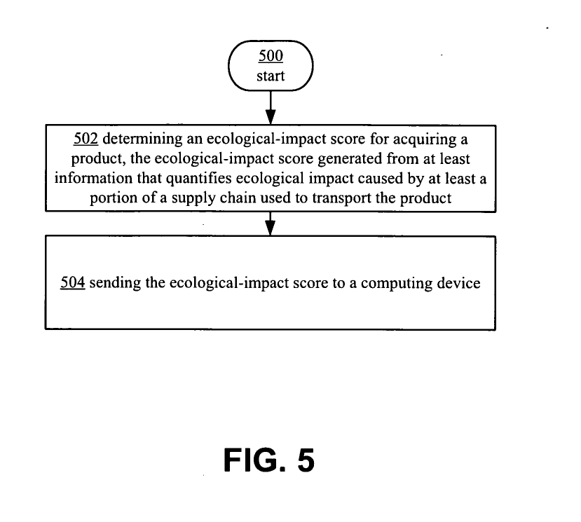

Device 302 can optionally include client-supply chain database circuitry 402, client-ecological-impact circuitry 418, and/or product profile database circuitry 414. Consequently, in embodiments of the present disclosure, the functionality described as being associated with ecological-impact circuitry 206, client-supply chain database circuitry204, and/or product profile database circuitry 202 could be integrated within device 302. Thus, in certain embodiments of the present disclosure, efficiency-of-use scores and/or ecological-impact scores may be computed by a device external to product 102 using data stored on device 302 and/or system 114. Accordingly, while certain operations described with respect to FIG. 5-FIG. 11 are described as being executed by system 114, these operations could be executed by device 302 in alternative embodiments.

Device 302 can obtain information form product 102 and/or product package 306 using barcode reader 406, device location determination circuitry 408, RFID reader circuitry 410, network adapter circuitry 422, or camera circuitry 404. In other exemplary embodiments, information can be obtained from system 114 or from supply chain database 420, product profile database 414 by using an image of product 102 obtained from camera circuitry 414, audio of a user speaking about product 102, or from user input.

FIG. 5 and the following figures include various examples of operational flows, discussions and explanations may be provided with respect to the above-described exemplary environment of FIGS. 1-4. However, it should be understood that the operational flows may be executed in a number of other environments and contexts, and/or in modified versions of FIGS. 1-4. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

Referring now to FIG. 5, it illustrates an operational procedure for practicing aspects of the present disclosure including operations 500, 502, and 504. As such, operation 500 beings the operational procedure and operation 502 illustrates determining an ecological-impact score for acquiring a product, the ecological-impact score generated from at least information that quantifies ecological impact caused by at least a portion of a supply chain used to transport the product. For example, and referring to FIG. 2, in an exemplary embodiment, ecological-impact circuitry 206 can determine an ecological-impact score for acquiring product 102. In an embodiment, ecological-impact circuitry 206, which could be effectuated by instructions that execute on a processor in a specific example, can determine, e.g., generate or retrieve from shipping infrastructure table 210, an ecological-impact score for acquiring product 102.

In this example, the ecological-impact score can reflect the ecological impact that is caused by the infrastructure used to effectuate at least a portion of a supply chain used to transport, e.g., move product 102 from point A to point B (where there may be intervening points between A and B and there may be additional points after B and before A). In a specific example, and referring briefly to FIG. 1, the ecological-impact score could be for a leg of a supply chain formed by manufacturer location 104, which could be a factory, warehouse, etc., and distribution center 106, which could be a warehouse. As such, the ecological-impact score could reflect the ecological impact caused by moving product 102 from a factory in China to a warehouse in a Chinese port city by truck; moving product 102 from the warehouse in China to a warehouse in Seattle, Wash. by boat; and moving product 102 from the warehouse in Seattle, Wash. to a distribution center in Seattle, Wash. owned by, for example, Wal-Mart®.

In an exemplary configuration, the ecological-impact score could be based at least in part on the amount of CO₂e generated by the method of transportation used to transport product 102 from one location to another, the CO₂e generated to power the warehouses used to store product 102 along the way, etc. For example, suppose that a shipping carrier uses a train to move product 102 from manufacturer location 104 to distribution center 106. In this example, shipping infrastructure table 210 could include an entry for the shipping carrier, e.g., FedEx®, that describes the amount of CO₂e generated by the trip (e.g., the amount CO₂e generated by the type of truck that moves product 102 from a factory in China to a warehouse in a Chinese port city, as well as ecological impact data for other parts of the trip), and information that describes the size, e.g., volume, and weight of product 102 (as well as the volume and weight of product 102 along with any packaging). In this example, ecological-impact circuitry 206 could use this information to compute an ecological-impact score for the leg. This score could be persisted so that it could be used when another instance of product 102 is shipped over the same leg.

In a specific example embodiment, the ecological-impact score could be computed by determining what portion of the total CO₂e can be attributed to product 102 based on the volume and weight information; and outputting a number and/or looking up a number, letter grade, word, and/or phrase that is associated with the determined portion of the total CO₂e. In another specific example, N number of different ecological impact variables (where N is an integer greater than 1) can be normalized and combined to generate an ecological-impact score. For example, a CO₂e variable and a variable that reflects how much waste was generated during the trip could be normalized and combined to compute an ecological-impact score.

Turning back to FIG. 5, operation 504 illustrates sending the ecological-impact score to a computing device. For example, and again referring to FIG. 2, networking circuitry 116, e.g., a network interface card and associated firmware/software, can send one or more packets of information indicative of the ecological-impact score to a computing device, e.g., a tablet computer system, a mobile phone, supplier web-server 118, device 302, etc. In an exemplary embodiment, ecological-impact score can be sent in an email, a text message, a document, an HTML file, an XML file, etc., to a computer system.

In a specific example, suppose that the computing device is a computer associated with a company that maintains supplier web-server 118; e.g., Amazon.com®. When a user orders a product the product is typically shipped from distribution center 106 to an acquiring entity location 108. In this example, system 114 may have previously received information that describes the infrastructure used to transport product 102 from manufacturer location 104 to distribution center 106. For example, the company may have provided information to system 114 that indicates what shipping carrier is used for the leg and what transportation method or methods is/are used. System 114 could have also computed an ecological-impact score for shipping product 102 via this leg and stored it in shipping infrastructure table 210. The ecological-impact score could be retrieved and sent to a computer system associated with the company. The ecological-impact score for this leg could be inserted within product description information for product 102. As such, when a user views the webpage for product 102 he or she can view an ecological impact score for this leg.

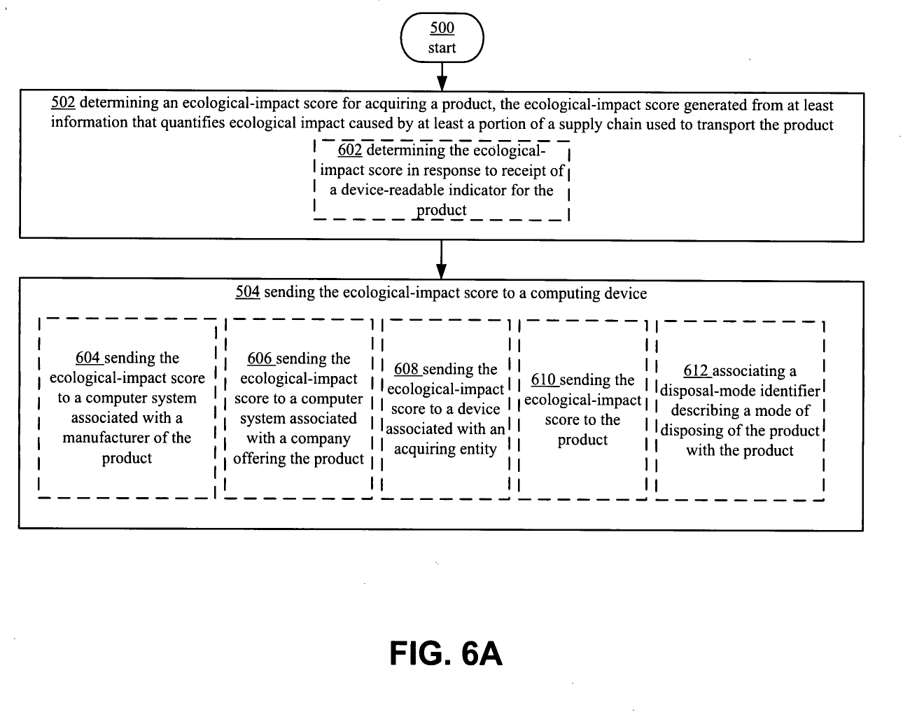

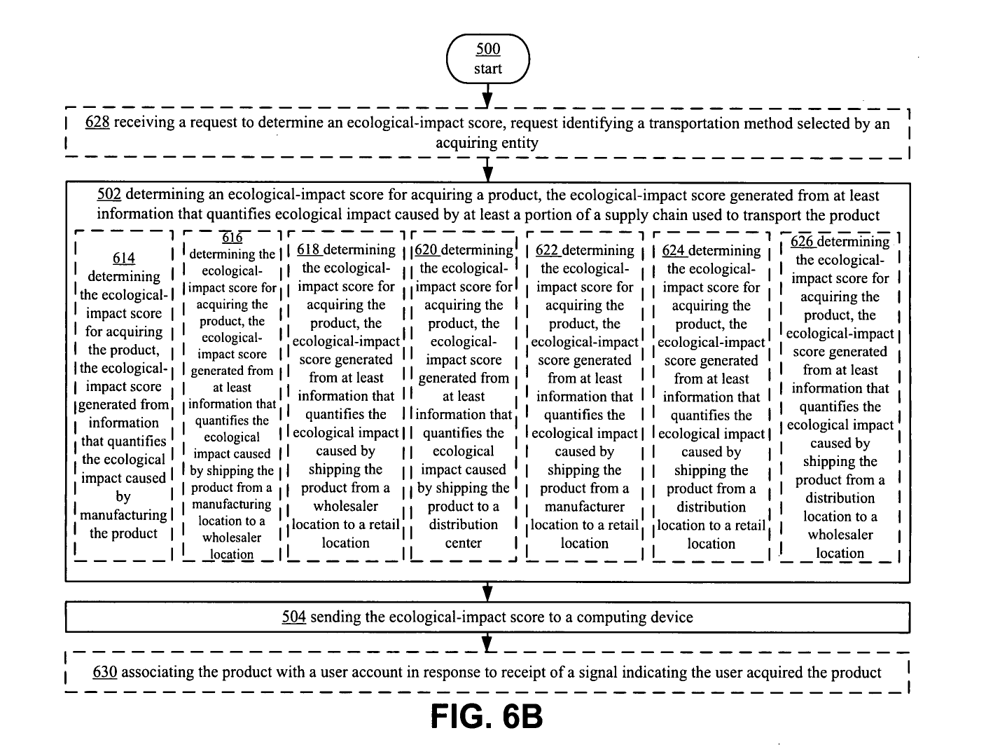

Referring now to FIG. 6A, it illustrates additional operations that can be executed in conjunction with those illustrated by FIG. 5. In particular, FIG. 6A illustrates additional operations 602-612. Turning to operation 602, it shows determining the ecological-impact score in response to receipt of a device-readable indicator for the product. For example, and again referring to FIG. 2, in an exemplary embodiment, ecological-impact circuitry 206 can be configured to determine an ecological-impact score for product 102 in response to receipt of a signal that includes a device-readable indicator for product 102.

In a specific example, device 302 could be used to scan product 102 and a request for an ecological-impact score could have been sent via network to system 114. In a specific example, device-readable indicator for product 102 can be encapsulated within a message that is received by networking circuitry 116. The message could include a field that identifies a device-readable indicator and a field that indicates that the message is a request for an ecological-impact score. In this specific example, the request could also include information that indicates what part of the supply chain the request is for, the identity of the company offering product 102 and/or the current location of product 102. For example, the message could be requesting a score that reflects the entire supply chain used to transport product from manufacturer location 104 to destination location 108, e.g., a user's home.

Continuing with the description of FIG. 6A, operation 604 illustrates sending the ecological-impact score to a computer system associated with a manufacturer of the product. For example, and referring to FIG. 1, in an embodiment an ecological-impact score can be sent to a computer system associated with a manufacturer of product 102, e.g., to a computer system associated with an organization that controls manufacturer location 104. The computer system could receive the ecological-impact score in an email, a spreadsheet, a document, etc. Once in possession of the ecological-impact score, an agent could attach the ecological impact score to product package 306 and/or product 102. In a specific example, suppose that the manufacturing company provides information to system 114 that identifies the shipping carrier used to ship product 102 to a wholesaler location 110 associated with a company such as Costco®. Ecological-impact circuitry 206 can determine an ecological-impact score for this leg from information that describes the infrastructure used by the shipping carrier and send it to the manufacturer, who could put the ecological-impact score in an RFID tag or on a sticker attached to product package 306.

Continuing with the description of FIG. 6A, operation 606 shows sending the ecological-impact score to a computer system associated with a company offering the product. For example, and referring to FIG. 1, in an embodiment an ecological-impact score can be sent to a computer system associated with a company that offers product 102, e.g., to a computer system associated with an organization that controls retail location 112 and/or wholesaler location 110. The computer system could receive the ecological-impact score in an email, a spreadsheet, a document, etc., and an agent could attach the ecological impact score to product package 306 and/or product 102. In a specific example, suppose that information that identifies the shipping carrier used to ship product 102 to a wholesaler location 110 or retail location 112 is stored in system 114. Ecological-impact circuitry 206 can determine an ecological-impact score for these legs from information that describes the infrastructure used by the shipping carrier and product 102 and send it to the manufacturer, who could put the ecological-impact score in a barcode or on a sticker attached to product package 306.

Continuing with the description of FIG. 6, operation 608 shows sending the ecological-impact score to a device associated with an acquiring entity. For example, and referring to FIG. 3, in an embodiment an ecological-impact score can be sent to a device 302. For example, the ecological-impact score can be sent in an email, text message, an HTML web-page, an XML document, etc. Device 302 can receive the ecological-impact score and cause user interface circuitry 412 to render an image indicative of the ecological-impact score.

In a specific example, suppose a user is at retail location 112 determining whether to purchase product 102. In this example, suppose that user 300 is interested in viewing information that describes how much harm was caused to the environment to get product 102 to retail location 112 and uses device 302 to take a picture of product 102. Networking circuitry 422 can send one or more packets of information indicative of the image to system 114. In addition to the image, user 300 may send information that indicates the identity and location of retail location 112.

Turning to FIG. 2, networking circuitry 116 can receive the message and it can be routed to ecological impact circuitry 206. Ecological-impact circuitry 206 can determine that the message is a request for an ecological-impact score for at least a part of the supply chain used to transport product 102 to retail location 112 and send a query to supply chain database circuitry 204. Supply chain database circuitry 204 can search through shipping infrastructure table 210 to find an ecological impact score for the leg. In the instance that one has not yet been persisted, information such as the shipping-method or methods used, the CO₂e information for each transportation method, size/weight information for product 102 can be used to compute an ecological-impact score. Networking circuitry 116 can send the ecological-impact score back to the IP address associated with device 302.

In a specific example, the company that controls retail location 112 may have previously uploaded information that describes the shipping carrier they use to get product 102 and the shipping carrier could have already uploaded information that can be used to quantify the ecological impact caused by the infrastructure used to ship product 112 to this retailer. The infrastructure information can be used to compute the ecological-impact score.

Turning back to FIG. 6, operation 610 shows sending the ecological-impact score to the product. For example, and referring to FIG. 3, in an embodiment, a user such as user 300 may be interested in the ecological impact caused by at least a portion of the supply chain used to transport product 102. For example, user 300 may be at product retailer location 112 of FIG. 1 and interested in purchasing product 102. In this example, and referring to FIG. 2, ecological-impact circuitry 206 can generate a message, e.g., an html file, that includes an ecological-impact score associated with product 102 and send it via networking circuitry 116 to a network address associated with product 102, e.g., a mobile phone, a tablet computer system, etc. Product 102 can receive the message and cause user interface circuitry 320, e.g., an LCD screen based user interface, to render an image that includes the ecological-impact score.

In an exemplary embodiment, ecological-impact circuitry 206 of FIG. 2 may have generated the message in response to a request received from product 102. For example, a user 300 may have pressed a button attached to product 102 and product 102 could send its device-readable identifier along with a product serial number to system 114 via networking circuitry 318. The message or messages can be received via networking circuitry 116 and ecological-impact circuitry 206 can determine the identity of product retail location 112 by looking up where this specific instance of product 102 was sold. Ecological-impact circuitry 206 can then use the identity of product retail location 112 and the device-readable indicator for product 102 to formulate a query that can be submitted to supply chain database circuitry 204. A score can be obtained and sent back to product 102 in a message, where it could be displayed by user interface 320.

Referring back to FIG. 6, operation 612 shows associating a disposal-mode identifier describing a mode of disposing of the product with the product. For example, and referring to FIG. 2 for context, in an embodiment system 114 can include product database circuitry 202. Product database circuitry 202 can include one or more disposal identifiers for product 102 stored in disposal mode identifier table 222. In a specific example, the disposal mode could be instructions that describe a way to dispose of product 102 according to a landfill mode of disposal. In the same, or another embodiment, the disposal mode could be associated with a disposal mode quantification that describes the ecological impact caused by disposing of product 102 according to the associated disposal mode.

Referring now to FIG. 6B it shows additional operations that can be executed in conjunction with those illustrated by FIG. 5. In particular, FIG. 6B illustrates operations 614-630. Operation 614 illustrates determining the ecological-impact score for acquiring the product, the ecological-impact score generated from information that quantifies the ecological impact caused by manufacturing the product. For example, in an exemplary embodiment, ecological-impact circuitry 206 can be configured to generate an ecological-impact score that includes the ecological harm caused by manufacturing product 102. In a specific example, the harm could be based on quantifications that quantify the CO₂e, the hazardous materials generated by the manufacturer, ground pollutants generated by the manufacturer, rare materials that are used up by making product 102 and/or rare materials that are in product 102, etc. Quantifications for each ecological-impact source can be determined and combined into an ecological-impact score.

In a specific example, suppose product 102 is a laptop. In this example, the manufacturer of the laptop could have generated energy consumption information for a factory that assembles the laptop. In this example, the amount of energy used to produce a single laptop and the source of that energy can be determined (for example, an energy-consumption analysis could be performed at the factor). From this information the amount of CO₂e emitted to manufacture the laptop can be estimated used to generate an ecological-impact score.

Turning again to FIG. 6B, operation 616 shows determining the ecological-impact score for acquiring the product, the ecological-impact score generated from at least information that quantifies the ecological impact caused by shipping the product from a manufacturing location to a wholesaler location. For example, and referring to FIG. 2 in conjunction with FIG. 1, ecological-impact circuitry 206 can be configured to generate an ecological-impact score that reflects the harm caused by shipping product 102 from manufacturer location 104, e.g., a factory in China, to a wholesaler location 110, e.g., a Costco® store in Seattle, Wash. Or put another way, the amount of ecological impact caused by the supply chain infrastructure represented by the arrow between manufacturing location 104 and wholesaler location 110 can be quantified and used to determine an ecological-impact score. For example, the amount of CO₂e generated, the amount of waste generated, etc., can be determined and the amount attributed to product 102 can be calculated, e.g., by using the size, weight, etc., information for product 102. An ecological-impact score can then be stored in shipping infrastructure table 210 in association with product 102 and sent to a computing device such as device 302.

Information that describes the infrastructure used by one or more shipping carriers to transport product 102 can be gathered by one or more agents. The information in a specific example could indicate that a shipping carrier ships product 102 by train to a port city in China; ships product 102 by boat from the Chinese port city to a port in Seattle, Wash.; and ships product 102 by truck to a wholesaler location, e.g., a Costco® store. In addition, information such as the type of truck and ship used as well as energy analysis information for warehouses used to store product 102 along the way can be determined. This information can be stored in shipping infrastructure table 210 and one or more ecological-impact scores can be determined from the information. The one or more score can be sent via networking circuitry 116 to other computer systems, e.g., a computer system controlled by Costco®, a computer system controlled by user 300, etc.

Referring to operation 618 of FIG. 6B, determining the ecological-impact score for acquiring the product, the ecological-impact score generated from at least information that quantifies the ecological impact caused by shipping the product from a wholesaler location to a retail location. For example, and referring to FIG. 2 in conjunction with FIG. 1, ecological-impact circuitry 206 can be configured to generate an ecological-impact score that reflects at least the harm caused by the infrastructure used to ship product 102 from wholesaler location 110, e.g., warehouse to a retail location 112. Or put another way, the amount of ecological impact caused by the supply chain infrastructure represented by the arrow between wholesaler location 110 and retail location 112 can be quantified can be quantified and used to determine an ecological-impact score. The amount of CO₂e generated, the amount of waste generated, etc., can be determined and the amount attributed to product 102 can be calculated, e.g., by using the size, weight, etc., information for product 102. An ecological-impact score can then be stored in shipping infrastructure table 210 in association with product 102 and sent to a computing device such as supplier web-server 118.

Information that describes the infrastructure used by one or more shipping carriers to transport product 102 can be gathered by one or more agents. The information in a specific example could indicate that a shipping carrier ships product 102 by truck from wholesaler location 110 to retail location 112. In addition, information such as the type of truck and ship used as well as energy analysis information for warehouses used to store product 102 along the way can be determined. This information can be stored in shipping infrastructure table 210 and one or more ecological-impact scores can be determined from the information. The one or more score can be sent via networking circuitry 116 to other computer systems, e.g., a computer system controlled by Costco®, a computer system controlled by user 300, etc.

Continuing with the description of FIG. 6B, operation 620 shows determining the ecological-impact score for acquiring the product, the ecological-impact score generated from at least information that quantifies the ecological impact caused by shipping the product to a distribution center. For example, and referring to FIG. 2 in conjunction with FIG. 1, ecological-impact circuitry 206 can be configured to generate an ecological-impact score that reflects the harm caused by shipping product 102 from manufacturer location 104, e.g., a warehouse in Texas operated by Texas Instruments®, to a distribution center 106, e.g., warehouse operated by Target®. Or put another way, the amount of ecological impact caused by the supply chain infrastructure used to ship, for example, a calculator, can be used to determine an ecological-impact score. The amount of CO₂e generated, the amount of waste generated, etc., can be determined and the amount attributed to product 102 can be calculated, e.g., by using the size, weight, etc., information for product 102. An ecological-impact score can then be stored in shipping infrastructure table 210 in association with product 102 and sent to a computing device such as product 102.

In a specific example, suppose that product 102 is an LCD TV and an agent for the shipping carrier used by the manufacturing entity previously sent information that describes the transportation method, e.g., type of truck used, distances traveled, fuel consumed, etc., to system 114. The information can be used to generate an ecological-impact score for the leg and the score can be stored in shipping infrastructure table 210. The score can then be disseminated to an entity that offers product 102 and ships it via this shipping carrier. Suppose that distribution center 106 is used by an online retailer such as Amazon.com® in this example. In the instance that a user 300 views a web-page for product 102 on supplier web-server 118 (which could be controlled by Amazon.com® in this example), the webpage for product 102 could include the ecological-impact score for product 102 that reflects the harm caused by transporting product to distribution center 106.

Continuing with the description of FIG. 6B, operation 622 shows determining the ecological-impact score for acquiring the product, the ecological-impact score generated from at least information that quantifies the ecological impact caused by shipping the product from a manufacturer location to a retail location. For example, and referring to FIG. 2 in conjunction with FIG. 1, ecological-impact circuitry 206 can be configured to generate an ecological-impact score that reflects the harm caused by shipping product 102 from manufacturer location 104, e.g., a storage facility associated with a company in Indiana that manufactured product 102, e.g., a washing machine, to a retail location, e.g., a Macy's® store in San Francisco, Calif. The amount of CO₂e generated, the amount of waste generated, etc., can be determined and the amount attributed to product 102 can be calculated, e.g., by using the size, weight, etc., information for product 102. An ecological-impact score can then be stored in shipping infrastructure table 210 in association with product 102 and sent to a computing device such as product 102.

In a specific example, and referring to FIG. 2, information that indicates that a company such as Wal-Mart® uses a shipping carrier to ship products, such as consumer electronics, home appliances, food, clothing, etc. to retail locations. Information that describes the ecological-impact caused by the infrastructure used to move products from a manufacturing location to a retail store can be received and stored in shipping infrastructure table 210. Ecological impact scores for this leg of a supply chain can be determined using information such as the amount of CO₂e, waste, etc., generated by the trains, trucks, warehouses, etc., can be determined and the amount attributed to each product transported via this method can be calculated, e.g., by using size, weight, etc., information for each individual product. Ecological-impact scores can then be stored in shipping infrastructure table 210 in association with product 102.

Continuing with the description of FIG. 6B, operation 624 shows determining the ecological-impact score for acquiring the product, the ecological-impact score generated from at least information that quantifies the ecological impact caused by shipping the product from a distribution location to a retail location. For example, and referring to FIG. 2 in conjunction with FIG. 1, ecological-impact circuitry 206 can be configured to generate an ecological-impact score that reflects the harm caused by shipping product 102, e.g., a washing machine, from a distribution center, e.g., a storage facility associated with Macy's in San Francisco, Calif. to retail location 112, e.g., a Macy's® store in downtown San Francisco, Calif. The amount of CO₂e generated, the amount of waste generated, etc., can be determined and the amount attributed to product 102 can be calculated, e.g., by using the size, weight, etc., information for product 102. An ecological-impact score can then be stored in shipping infrastructure table 210 in association with product 102 and sent to a computing device such as product 102.

Continuing with the description of FIG. 6B, operation 626 shows determining the ecological-impact score for acquiring the product, the ecological-impact score generated from at least information that quantifies the ecological impact caused by shipping the product from a distribution location to a wholesaler location. For example, and referring to FIG. 2 in conjunction with FIG. 1, ecological-impact circuitry 206 can be configured to generate an ecological-impact score that reflects the harm caused by shipping product 102, e.g., a leather sofa, from distribution center106, to wholesaler location 110. The amount of CO₂e generated, the amount of waste generated, etc., can be determined and the amount attributed to product 102 can be calculated, e.g., by using the size, weight, etc., information for product 102. An ecological-impact score can then be stored in shipping infrastructure table 210 in association with product 102 and sent to a computing device such as product 102.

Continuing with the description of FIG. 6B, operation 628 shows receiving a request to determine an ecological-impact score, the request identifying a transportation method selected by an acquiring entity. In an exemplary embodiment, an ecological-impact score can be determined by ecological-impact circuitry 206 that takes into account harm caused by an acquiring entity's choices when acquiring product 102. For example, and referring to FIG. 2, networking circuitry 116 can receive a message, e.g., one or more packets of information, that includes a request to determine an ecological-impact score for product 102. In this example, the message can additionally identify a transportation method selected by the acquiring entity. For example, the message could indicate that an acquiring entity has traveled to a retail location to purchase product 102, that an acquiring entity has requested that product 102 be shipped by a priority air transportation method, etc.

Upon receipt of the message, networking circuitry 116 can route the message to ecological-impact circuitry 206, which can parse the message and determine the transportation method selected by the acquiring entity the address of the retail location or the address of the distribution center used to ship product 102. In the instance where a user 300 is at retail location 112 contemplating a purchase of product 102, ecological-impact circuitry 206 can identify product 102 from the request and receive information from user 300, device 302, or an agent for retail location 112 that obtains such information from user 300, that describes the ecological impact caused by user 300 to travel between retail location 112 and acquiring entity location 108 to acquire product 102. The amount of CO₂e generated, the amount of waste generated, etc., can be determined and the amount attributed to product 102 can be calculated, e.g., by using the size, weight, etc., information for product 102. An ecological-impact score can then be stored in shipping infrastructure table 210 in association with product 102 and sent to a computing device such as product 102.

Alternatively, in the instance where user 300 is contemplating a purchase of product 102 over the Internet, user 300 may be viewing information about product 102 on a web-page generated by supplier web-server 118. In this example, ecological-impact circuitry 206 can receive a request to generate an ecological-impact score that reflects the ecological-impact caused by shipping product 102 to acquiring entity location 108, e.g., a user's house. In response to receipt of the request, ecological-impact circuitry 206 can submit a query to supply chain database circuitry 204 for an ecological-impact score that reflects at least the infrastructure used to transport product 102. A score can be received by ecological-impact circuitry 206, which can generate a message indicative of the same and send it to the computer that submitted the request, e.g., device 302 or supplier web-server 118.

An ecological-impact score that takes into account this leg of the supply chain could have been previously generated and stored in shipping infrastructure table 210. This ecological-impact score can be used to quantify the leg of the supply chain that delivers product 102 to an acquiring entity. For example, the shipping carrier used to ship product 102 to an acquiring entity's location, e.g., an office building, home, etc., could have uploaded information to system 114 that describes the infrastructure used by the carrier to ship product 102 the last leg, i.e., to an acquiring entity. The information could include information that identifies what type of vehicles it uses, how much energy the vehicles consume, the standard routes the vehicles use, etc. This information can be used to determine one or more ecological-impact scores.

Continuing with the description of FIG. 6B, operation 630 shows associating the product with a user account in response to receipt of a signal indicating the user acquired the product. For example, and referring to FIG. 2, association circuitry 254 can be configured to link a user account for user 300, e.g., user account 252, with product 102 and store the information in user account database circuitry 250. Association circuitry 254 can be configured to link user account 250 with product 102 in response to receipt of a signal by networking circuitry 116 that indicates that user 300 has acquired, e.g., purchased product 102. For example, networking circuitry 116 could receive one or more packets of information indicative of an XML package that includes fields that identify product 102, the user account for user 300 (user account 252), and an indication that user 300 has purchased product 102.

In an exemplary embodiment, each user that consumes products may have a user account in user account database circuitry 250. However, in another embodiment, multiple users may share a user account and/or the user account could be associated with an entity such as a family unit or a corporation. For example, a user account could be for the “Smith family.” In this example, when any member of the Smith family, e.g., Mr. Smith or Ms. Smith, purchases a product a signal can be sent received by association circuitry 254 and information can be stored that indicates that a member of the Smith family has purchased a product.

In a specific example, user account database circuitry 250 can store user accounts for users that acquire products from one or more companies. For example, suppose that user account database circuitry 250 stores user accounts for a company such as Wal-Mart®. In this example, suppose a user 300 visited a Wal-Mart® retail location and decided to purchase product 102, which is an LCD TV in this example. When user 300 pays for the TV an employee of the store may ask the user for his or her user account name, his or her real name, address, etc., and enter it into a computer system. The computer system can send a message that includes the user's information as well as a device-readable indicator for the LCD TV. Networking circuitry 116 can receive the message and determine that it is a product association message based on information in the header. In response to this determination, networking circuitry 116 can route the message to association circuitry 254. Association circuitry 254 can determine that user account 250 is associated with this user from information in the message and link user account 250 with the LCD TV.

In another specific example, suppose a user 300 is shopping online and viewing a web-page generated by supplier web-server 118 that includes information about product 102, which in this example is a book. In this example, suppose user 300 decided to purchase the book and provides a credential for user account 250. When user 300 buys the book supplier web-server 118 can generate a message that includes an identifier for user account 250 as well as a device-readable indicator for the book. Networking circuitry 116 can receive the message and determine that it is a product association message based on information in the header. In response to this determination, networking circuitry 116 can route the message to association circuitry 254. Association circuitry 254 can determine that user account 250 is associated with this user from information in the message and link user account 250 with the book.

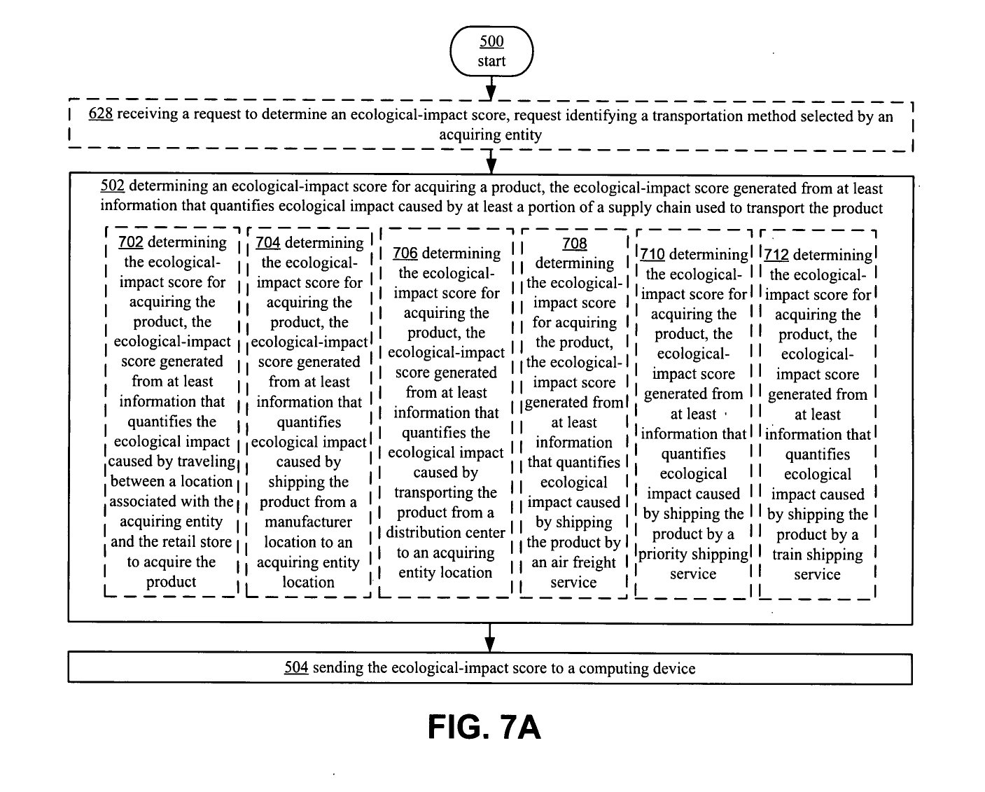

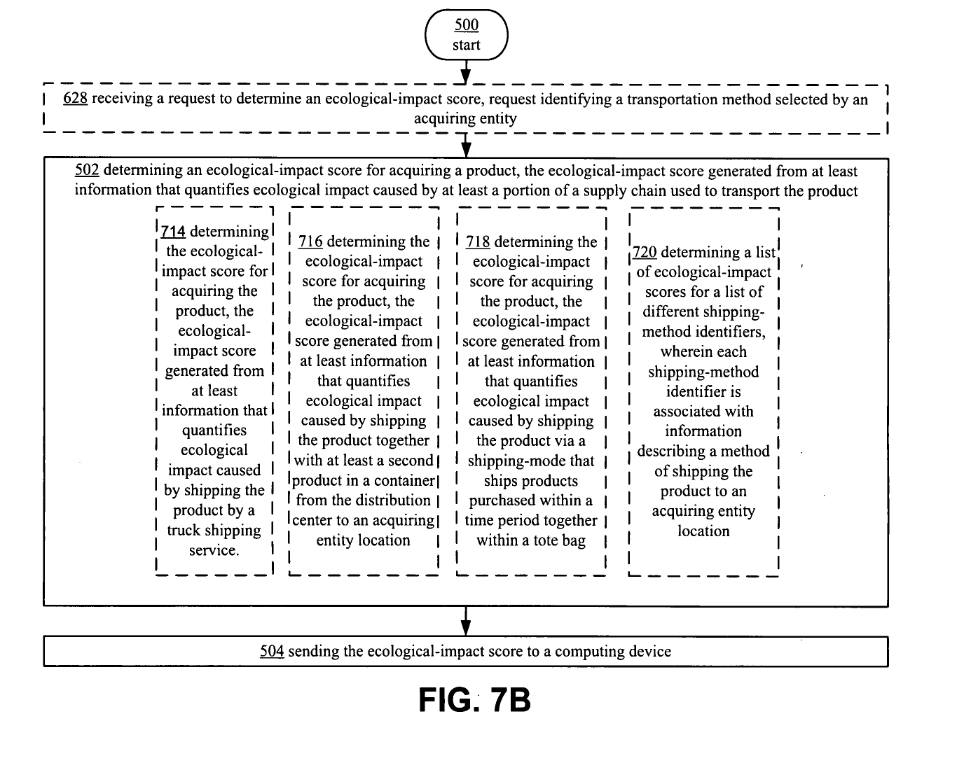

Referring now to FIG. 7A, it illustrates additional operations 702-712. Turning to operation 702, it shows determining the ecological-impact score for acquiring the product, the ecological-impact score generated from at least information that quantifies the ecological impact caused by traveling between a location associated with the acquiring entity and the retail store to acquire the product. For example, and again turning to FIG. 1 in conjunction with FIG. 2, in an embodiment, ecological-impact circuitry 206 can determine an ecological-impact score that reflects ecological harm caused by a user that travels to retail location 112 to acquire product 102. For example, information such as the amount of CO₂e generated by user 300 as he or she travels to retail location 112 or wholesaler location 110 can be determined. An ecological-impact score can then be stored in shipping infrastructure table 210 in association with product 102 and sent to a computing device such device 302.

In an example embodiment, user 300 may acquire product 102 from retail location 112 or wholesaler location 110. In this example, the last leg can be computed from information captured by an employee of retail location 112 or wholesaler location 110. The information can describe the transportation method, e.g., the number of miles traveled, time traveling, speed, vehicle type, etc. System 114 can receive the information and access supply chain database 210 to look up the transportation method used by user 300, e.g., bus, car, bike, etc., and use information such as the number of miles drive, average speed, time spent traveling, etc., to compute an ecological-impact score for this leg.

In another configuration, suppose device 302 is a mobile device and includes device location determination circuitry 408, e.g., a GPS receiver. In this example, the GPS receive could be activated and can track the path used by user 300 to go to product retail location 112 or wholesaler location 110. When user 300 purchase product 102 he or she can use user interface circuitry 412, e.g., a touch display, to input information that indicates that user 300 has acquired product 102 and the transportation method used to get to product retailer 102. System 114 can receive the information and access supply chain database 210 to look up the transportation method used by user 300 to obtain speed information, average miles per gallon of gas information achieved, etc., and use this information as well as distance information to compute an ecological-impact score for this leg of the journey.

Referring to operation 704 of FIG. 7A, it shows determining the ecological-impact score for acquiring the product, the ecological-impact score generated from at least information that quantifies ecological impact caused by shipping the product from a manufacturer location to an acquiring entity location. For example, and again turning to FIG. 1 in conjunction with FIG. 2, in an embodiment, ecological-impact circuitry 206 can determine an ecological-impact score that reflects the harm caused by shipping product 102 from manufacturer location 104, e.g., a storage facility associated with a company in Texas that manufactured product 102, e.g., a laptop, to an acquiring entity location, e.g., a consumer's house in Columbus, Ohio.

For example, and referring to FIG. 2, information that describes the shipping methods used by manufacturer location 104 to ship to acquiring entities can be entered into supply chain database 210. For example, the shipping options could include those offered by United States Parcel Service® such as Priority Mail®, Express Mail®, etc., and/or shipping options offered by a company such as FedEx®, e.g., a priority air service, a regular air service, a ground shipping service, a freight shipping service, etc and the carriers may have previously uploaded information about the infrastructure used to system 114. This information can be used to generate an ecological-impact score for at least a portion of the supply chain used to transport product 102 to acquiring entity location 108, e.g., a user's home. In this example, ecological-impact circuitry 206 can receive a request to determine an ecological-impact score and send a query to supply chain database circuitry 204. Supply chain database circuitry 204 can search for an ecological-impact score within shipping infrastructure table 210 that was computed from information such as the size/weight information for product 102, product package 306, and the ecological-impact caused by the infrastructure used to ship product from the storage facility to Columbus, Ohio.

For example, suppose a user 300 wishes to purchase product 102 by navigating to a web-page that shows product 102, which could be generated by supplier web-server 118. In this example, user 300 can provide a shipping destination and it can be routed to ecological-impact circuitry 206, along with a request to compute an ecological impact score that takes into account at least the ecological-impact caused by shipping product 102 to acquiring entity location 108. For example, a priority air service may include potential ecological harm associated with the truck used to move product 102 to the air port; the harm that will be caused by the plane that transports product 102 to the city including acquiring entity location 108; and the harm caused by the truck that will transport product 102 to acquiring entity location 108. The ecological-impact score can then be sent back to supplier web-server 118, which can display the score on a web-page.

In another embodiment, suppose that supplier web-server 118 had previously obtained ecological-impact scores that reflect the ecological-impact caused to transport product 102 to acquiring entity location 108. For example, suppose that the shipping carrier had previously uploaded supply chain information that describes the routes taken by the trucks that service the area that includes acquiring entity location 108 and an ecological-impact score that describes the ecological-impact caused by shipping a different instance of product 102 within the area had been determined; stored in shipping infrastructure table 210; and communicated to a computer system associated with supplier web-server 118. As such, the previously obtained ecological-impact score can be displayed on a web-page associated with product 102.

Referring back to FIG. 7A, operation 706 shows determining the ecological-impact score for acquiring the product, the ecological-impact score generated from at least information that quantifies the ecological impact caused by transporting the product from a distribution center to an acquiring entity location. For example, and again turning to FIG. 1 in conjunction with FIG. 2, in an embodiment, ecological-impact circuitry 206 can determine an ecological-impact score that reflects the harm caused by shipping product 102 from distribution center 106, e.g., a storage facility, to acquiring entity location 108, e.g., an office in New York City, N.Y. For example, and referring to FIG. 2, information that describes the infrastructure used by an entity offering product 102 can be entered into supply chain database 210. For example, suppose that a company such as Amazon.com® sells product 102 and has engaged a shipping service to transport product 102 to acquiring entity locations within New York City, N.Y. and suppose that this carrier has previously uploaded information about the infrastructure used to system 114. In this example, ecological-impact circuitry 206 can receive a request to determine an ecological-impact score and send a query to supply chain database circuitry 204. Supply chain database circuitry 204 can search for an ecological-impact score within shipping infrastructure table 210 that was computed from information such as the size/weight information for product 102, product package 306, and the ecological-impact caused by the infrastructure used to ship product from the storage facility to the office in New York City, N.Y.

In a specific example, suppose a user 300 wishes to purchase product 102 by navigating to a web-page that shows product 102, which could be generated by supplier web-server 118. In this example, user 300 can provide a shipping destination and it can be routed to ecological-impact circuitry 206 along with a request for an ecological impact score that takes into account at least the ecological-impact caused by shipping product 102 to acquiring entity location 108. The request could identify the company submitting the request, the identity of product 102, the address for acquiring entity location 108, the address for the distribution center 106, etc. Ecological-impact circuitry 206 can extract the information and submit a query to supply chain database circuitry 204, which can look up an ecological-impact score that matches this query and send it back to ecological-impact circuitry 206. Ecological-impact circuitry 206 can generate a message including the ecological-impact score and send it to a network identifier associated with a requesting computer system, e.g., supplier web-server 118, device 302, a computer system located at retail location 112, etc.

Continuing with the description of FIG. 7A, operation 708 shows determining the ecological-impact score for acquiring the product, the ecological-impact score generated from at least information that quantifies ecological impact caused by shipping the product by an air freight service. For example, and again turning to FIG. 1 in conjunction with FIG. 2, in an embodiment, ecological-impact circuitry 206 can determine an ecological-impact score that reflects the harm caused by shipping product 102 to acquiring entity location 108, e.g., a user's home located in Chicago, Ill. For example, and referring to FIG. 2, information that describes the infrastructure used by an entity offering product 102 can be entered into supply chain database 210. For example, suppose that a company such as Target® sells product 102 and has engaged a shipping service such as FedEx® to transport product 102 to acquiring entity locations within Chicago, Ill., from a regional distribution center in, for example, Lexington, Ky. In this example, one of the shipping services offered by the shipping carrier could be an air freight service. In this example, ecological-impact circuitry 206 can receive a request to determine an ecological-impact score and send a query to supply chain database circuitry 204. Supply chain database circuitry 204 can search for an ecological-impact score within shipping infrastructure table 210 that was computed from information such as the size/weight information for product 102, product package 306, and the ecological-impact caused by the infrastructure used to ship product from the regional distribution facility to the user's home in Chicago, Ill.

For example, and suppose a user 300 wishes to purchase product 102 by calling a phone number and speaking with an order placement agent. In this example, user 300 can provide a shipping destination and indicate that he or she wants product 102 as fast as possible. The order placement agent can input it into a computer system, which can a message to networking circuitry 116. The message can be routed to ecological-impact circuitry 206 along with a request for an ecological impact score that takes into account at least the ecological-impact caused by shipping product 102 to acquiring entity location 108. The request could identify the company submitting the request, the identity of product 102, the address for acquiring entity location 108, the address for the distribution center 106, information that indicates that air freight was selected as the shipping method, etc. Ecological-impact circuitry 206 can extract the information and submit a query to supply chain database circuitry 204, which can search for an ecological-impact score within shipping infrastructure table 210 that was computed from information such as the size/weight information for product 102, product package 306, and the ecological-impact caused by the infrastructure used to ship product via air freight service. Ecological-impact circuitry 206 can generate a message including the ecological-impact score and send it to a network identifier associated with the order placement agent's computer system. The order placement agent can then communicate the ecological-impact score to user 300 over the phone, have the score printed on an invoice for product 102, etc.

Continuing with the description of FIG. 7A, operation 710 shows determining the ecological-impact score for acquiring the product, the ecological-impact score generated from at least information that quantifies ecological impact caused by shipping the product by a priority shipping service. For example, and again turning to FIG. 1 in conjunction with FIG. 2, in an embodiment, ecological-impact circuitry 206 can determine an ecological-impact score that reflects the harm caused by the selection of a priority shipping service, e.g., next day air, to ship product 102 to acquiring entity location 108, e.g., an office. Suppose in an example the request is to ship product 102 from manufacturer location 104, e.g., a warehouse, to acquiring entity location 108.

Ecological-impact circuitry 206 can receive a request to determine an ecological-impact score and submit a query to supply chain database 210. In this example, the request could indicate the identity of product 102, the address for acquiring entity location 108, the address for manufacturer location 104, information that indicates that next day air was selected as the shipping method, etc. Supply chain database circuitry 204 can look up an ecological-impact score within shipping infrastructure table 210 that was computed from information such as the size/weight information for product 102, product package 306, and the ecological-impact caused by the infrastructure used to ship product via a priority shipping service. In the instance that an entry exists, supply chain database circuitry 204 can send it back to ecological-impact circuitry 206; otherwise, ecological-impact circuitry 206 can compute an ecological-impact score. Ecological-impact circuitry 206 can generate a message including the ecological-impact score and send it to a network identifier associated with a requesting computer system, e.g., supplier web-server 118, device 302, a computer system located at retail location 112, etc.

Continuing with the description of FIG. 7A, operation 712 shows determining the ecological-impact score for acquiring the product, the ecological-impact score generated from at least information that quantifies ecological impact caused by shipping the product by a train shipping service. For example, and again turning to FIG. 1 in conjunction with FIG. 2, in an embodiment, ecological-impact circuitry 206 can determine an ecological-impact score that reflects the harm caused by shipping product 102 to acquiring entity location 108 via a transportation method that involves use of one or more trains. For example, a shipping carrier may use one or more trains and information that describes the types of trains, the location of the shipping lines used, etc., can be uploaded to system 114 and used along with information about product 102, e.g., a mobile device, to determine an ecological-impact score for product 102.

In response to receipt of a request for an ecological-impact score, ecological-impact circuitry 206 can submit a query to supply chain database 210. In this example, the query could indicate the identity of product 102, the address for acquiring entity location 108, the (address of the place where product 102 is being shipped from, information that indicates that a shipping method was selected. Supply chain database circuitry 204 can look up an ecological-impact score within shipping infrastructure table 210 that was computed from information such as the size/weight information for product 102, product package 306, and the ecological-impact caused by the infrastructure used to ship product via a transportation method that includes trains. In the instance that an entry exists, supply chain database circuitry 204 can send it back to ecological-impact circuitry 206; otherwise, ecological-impact circuitry 206 can compute an ecological-impact score. Ecological-impact circuitry 206 can generate a message including the ecological-impact score and send it to a network identifier associated with a requesting computer system, e.g., supplier web-server 118, device 302, a computer system located at retail location 112, etc.

Turning now to FIG. 7B, it illustrates operations 714-720. Referring to operation 714, it shows determining the ecological-impact score for acquiring the product, the ecological-impact score generated from at least information that quantifies ecological impact caused by shipping the product by a truck shipping service. For example, and again turning to FIG. 1 in conjunction with FIG. 2, ecological-impact circuitry 206 can determine an ecological-impact score that reflects the harm caused by shipping product 102 to acquiring entity location 108 via a transportation method that includes use of trucks. For example, a shipping carrier may use one or more trucks and information that describes the types of trucks, the routes the tucks use, etc., can be uploaded to system 114 and used along with information about product 102, e.g., a mobile device, to determine an ecological-impact score for product 102.

In response to receipt of a request for an ecological-impact score, ecological-impact circuitry 206 can submit a query to supply chain database 210. In this example, the query could indicate the identity of product 102, the address for acquiring entity location 108, the address of the place where product 102 is being shipped from, information that indicates that a shipping method was selected. Supply chain database circuitry 204 can look up an ecological-impact score within shipping infrastructure table 210 that was computed from information such as the size/weight information for product 102, product package 306, and the ecological-impact caused by the infrastructure used to ship product via a transportation method that includes trucks. In the instance that an entry exists, supply chain database circuitry 204 can send it back to ecological-impact circuitry 206; otherwise, ecological-impact circuitry 206 can compute an ecological-impact score. Ecological-impact circuitry 206 can generate a message including the ecological-impact score and send it to a network identifier associated with a requesting computer system, e.g., supplier web-server 118, device 302, a computer system located at retail location 112, etc.

Continuing with the description of FIG. 7B, operation 716 shows determining the ecological-impact score for acquiring the product, the ecological-impact score generated from at least information that quantifies ecological impact caused by shipping the product together with at least a second product in a container from the distribution center to an acquiring entity location. For example, ecological-impact circuitry 206 can determine an ecological-impact score that reflects the harm caused by shipping multiple products within the same shipping container, i.e., within the same cardboard box. This has the effect of reducing the ecological harm caused by shipping products because products can be shipped in batches, i.e., a Blu-ray® player is shipped with a Blu-ray® disc. As such, the number of boxes used to ship products is reduced, the amount of space the boxes take is reduced, and the number of trips needed to deliver products to an acquiring entity is potentially reduced.

In response to receipt of a request for an ecological-impact score, ecological-impact circuitry 206 can submit a query to supply chain database 210 for infrastructure information used to ship product 102. For example, the query could identify an address for the location where the products are shipped to, e.g., a distribution center, an address for acquiring entity location 108, and the shipping method used. Supply chain database circuitry 204 can look up an ecological-impact score within shipping infrastructure table 210 that was computed from information such as the size/weight information for product 102, product package 306, and the ecological-impact caused by the infrastructure used to ship product. In the instance that an entry exists, supply chain database circuitry 204 can send it back to ecological-impact circuitry 206; otherwise, ecological-impact circuitry 206 can compute an ecological-impact score. Ecological-impact circuitry 206 can generate a message including the ecological-impact score and send it to a network identifier associated with a requesting computer system, e.g., supplier web-server 118, device 302, a computer system located at retail location 112, etc.

Continuing with the description of FIG. 7B, operation 718 shows determining the ecological-impact score for acquiring the product, the ecological-impact score generated from at least information that quantifies ecological impact caused by shipping the product via a shipping-mode that ships products purchased within a time period together within a tote bag. Similar to operation 716, multiple products can be combined and shipped together; however, in this example the entity offering product 102 may offer a service that gathers products ordered within a predetermined time period, e.g., a week, and delivers them all together in a tote bag, e.g., an open container that can be easily reused. As such, in this embodiment, the act of shipping product 102 may be delayed so that orders can be batched and a reusable bag can be used to ship products acquired during the predetermined time period. This has the effect of reducing the ecological harm caused by shipping the products by sending many products together within a reusable bag.

In a specific example, suppose that a company that controls supplier web-server 118 offers a tote-bag delivery service. In this example, a user may view products offered by the company and determine to acquire one. In this example, user 300 may select a tote-bag shipping method and a request for an ecological-impact score can be sent to system 114. For example, the request could indicate that the tote-bag shipping method was selected and the acquiring entity's address. Networking circuitry 116 can receive the request and route it to ecological-impact circuitry 206. Ecological-impact circuitry 206 can retrieve information from shipping infrastructure table 208 that indicates the ecological impact caused by the infrastructure used to effectuate the tote-bag delivery method and obtain information that indicates the weight and size of the tote-bag (based on the items that are already in the tote-bag) and compute an ecological-impact score. Ecological-impact circuitry 206 can generate a message including the ecological-impact score and send it to a network identifier associated with a requesting computer system, e.g., supplier web-server 118, device 302, a computer system located at retail location 112, etc.

Referring back to FIG. 7B, operation 720 illustrates determining a list of ecological-impact scores for a list of different shipping-method identifiers, wherein each shipping-method identifier is associated with information describing a method of shipping the product to an acquiring entity location. For example, ecological-impact circuitry 206 can generate one or more ecological-impact scores: one for each shipping-method that is available to ship product 102 to acquiring entity location 108. For example, suppose that next day air method, a second-day air method, and a ground method are available for product 102.

In response to receipt of a request, ecological-impact circuitry 206 can extract the shipping-method identifiers and submit a query to supply chain database circuitry 204 that identifies the company offering product 102, the address of acquiring entity location 108, the identity of the product, etc. Supply chain database circuitry 204 can look up multiple ecological-impact scores within shipping infrastructure table 210 that were computed from information such as the size/weight information for product 102, product package 306, and the ecological-impact caused by the infrastructure used to ship product via the different transportation methods. In the instance that an entry exists, supply chain database circuitry 204 can send it back to ecological-impact circuitry 206; otherwise, ecological-impact circuitry 206 can compute an ecological-impact score. Ecological-impact circuitry 206 can generate a message including the ecological-impact score and send it to a network identifier associated with a requesting computer system, e.g., supplier web-server 118, device 302, a computer system located at retail location 112, etc.

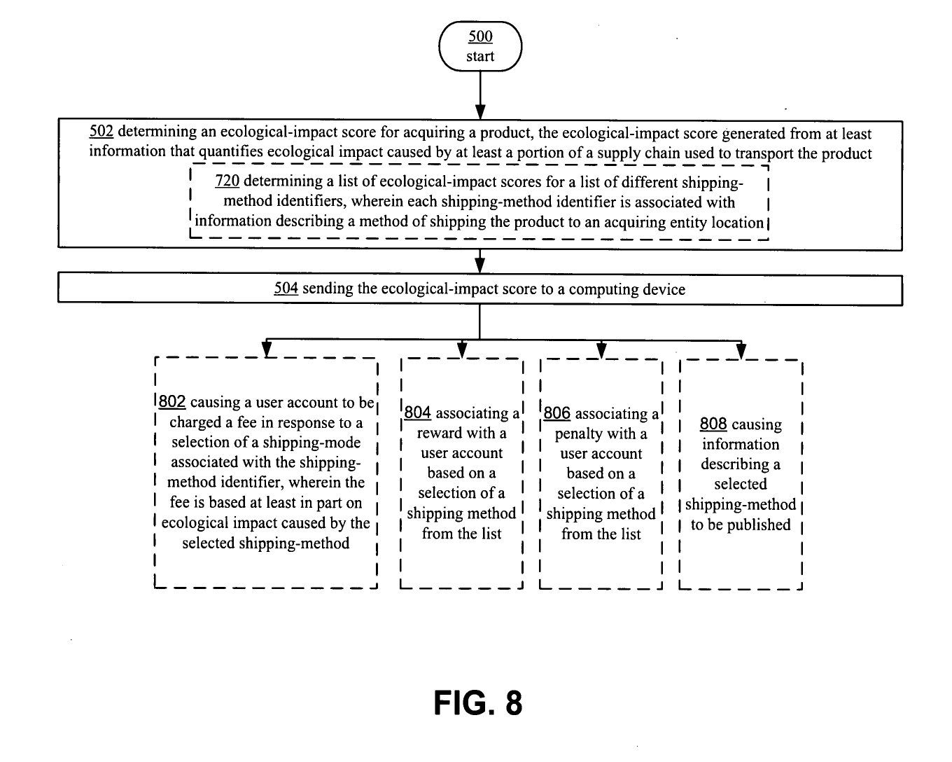

Turning now to FIG. 8, it illustrates additional operations 802-808. As such, operation 802 shows causing a user account to be charged a fee in response to a selection of a shipping-mode associated with the shipping-method identifier, wherein the fee is based at least in part on ecological impact caused by the selected shipping-method. For example, and again referring to FIG. 2, in this embodiment, system 114 can include accounting circuitry 240, e.g., a module of executable instructions that can run on a central processing unit. In this example, accounting circuitry 240 can be configured to charge user 300 a fee based on what shipping-method the user selects when shipping product 102 to acquiring entity location 108. For example, accounting circuitry 240 could include a table of information that maps ecological-impact scores to fees, which can be set by, for example, a company that is selling product 102, the government, a “Green Organization,” etc. For example, if the score is a value such as 0-10, in an embodiment each integer could be associated with a different fee. Thus, the more ecologically friendly the shipping method, the lower the additional fee charged to a user account associated with user 300. In another embodiment, the fee may only be applied to ecological-impact scores over a threshold. In another exemplary embodiment, the score could be more abstract such as “bad,” “good,” or a letter value such as A, B, C, D, or F.

Continuing with the description of FIG. 8, operation 804 shows associating a reward with a user account based on a selection of a shipping method from the list. For example, in an exemplary embodiment, user 300 can be given a reward based on his or selection of a shipping-method from the list. For example, and referring to FIG. 2, reward/penalty circuitry 256 can be configured to receive a message from that includes an identifier for user account 250, an identifier for product 102, and information that describes a shipping-method that was selected to ship product 102. Reward/penalty circuitry 256 can parse the message; lookup product 102; and determine if a selection of product 102 in conjunction with the selected shipping-method is associated with a penalty. In this example, reward/penalty circuitry 256 can determine to grant user 300 a reward and store information indicative of a reward in reward/penalty user information table 258. In an exemplary embodiment, the reward could be a coupon, a trophy Icon that can be integrated into an email signature block, information that causes product 102 to indicate that it was transported to user 300 in an efficient way (for example, product 102 may change color to indicate that it was shipped to user 300 in an environment friendly way), information that causes a third party to grant enhanced level of service to user 300, e.g., cheaper monthly cable bill, etc., money, tickets to the movies, etc. Once the information is stored in user information table 258, user 300 may access it via a web-page that displays his or her user account. In some instances, user 300 may print off tickets or other printable rewards. In others, the association of a reward will cause system 114 to communicate with a third party to enhance a service associated with user, e.g., decreased cable bill.

In a specific example, suppose user 300 is viewing product 102 on a webpage, which is a rice cooker in this specific example. In this example, user 300 determines to purchase the rice cooker and views the shipping-methods for delivering the rice cooker to the user's house, i.e., a specific example of an acquiring entity location. In this example, suppose the methods are priority air, two-day shipping, ground, and tote service. Each one of the shipping methods can be associated with an ecological-impact score that describes how harmful the shipping method is to the environment. For example, suppose priority air is the most harmful option available and the tote service is the most ecological friendly. In this example, user 300 may select the tote service to ship the rice cooker. In response to the selection, a signal can be sent to reward/penalty circuitry 256, which can determine that the combination of the rice cook along with the tote service is associated with a reward. Reward/penalty circuitry 256 can determine to grant user 300 a reward and store information indicative of a reward in reward/penalty user information table 258.

Turning now to operation 806, it shows associating a penalty with a user account based on a selection of a shipping method from the list. For example, in an exemplary embodiment, user 300 can be penalized based on his or selection of a shipping-method from the list. For example, and referring to FIG. 2, reward/penalty circuitry 256 can be configured to receive a message from that includes an identifier for user account 250, an identifier for product 102, and information that describes a shipping-method that was selected to ship product 102. Reward/penalty circuitry 256 can parse the message; lookup product 102; and determine if a selection of product 102 in conjunction with the selected shipping-method is associated with a penalty. In this example, reward/penalty circuitry 256 can determine to penalize user 300 and store information indicative of a penalty in reward/penalty user information table 258. In an exemplary embodiment, the penalty could be a negative status icon, which is integrated into an email signature block, information that causes product 102 to indicate that it was shipped using an environment unfriendly way (for example, product 102 may change color to indicate that it was shipped using an environmentally unfriendly way), information that causes a third party to reduce the level of service to user 300, e.g., more expensive cellular phone bill, etc., etc.

In a specific example, suppose user 300 is viewing product 102 on a webpage. For example, the product 102 could be a cellular phone. In this example, user 300 determines to purchase the cellular phone and views the shipping options for delivering the rice cooker to the user's house, i.e., a specific example of an acquiring entity location. In this example, suppose the options are priority air, two-day shipping, ground, and tote service. Each one of the shipping options can be associated with an ecological-impact score that describes how harmful the shipping method is to the environment. For example, suppose priority air is the most harmful option available and the tote service is the most ecological friendly. In this example, user 300 may select the priority air service. In response to the selection, a signal can be sent to reward/penalty circuitry 256, which can determine that the combination of the cellular phone along with the priority air service is associated with a penalty. Reward/penalty circuitry 256 can determine to penalize user 300 by storing information indicative of a reward in reward/penalty user information table 258.

Continuing with the description of FIG. 8, operation 808 shows causing information describing a selected shipping-method to be published. For example, in this embodiment, the selected shipping-method could be published, which could shame or honor user 300, depending on the ecological-impact score associated therewith. For example, ecological-impact circuitry 206 can generate a message that includes the efficiency-of-use score, a user account, and a product identifier and route the message to web-server circuitry 236, which can in turn cause the efficiency-of-use score to be published by causing it to be displayed by a web-page.

In another specific example, and referring to FIG. 1, media distribution center 120, which could be maintained by a third party (the government, product distributor 120, etc.), can disseminate information that is at least based in part on the efficiency-of-use score. In this example, system 114 could cause the selected shipping-method to be published by sending a signal to media distribution center 120, e.g., one or more packets of information. The signal could be received by a computer system at media distribution center 120 and media distribution center 120 could then publish selected shipping-method. Media distribution center 120 could be an organization that allows users to create Internet-based journals, e.g., blogs. In this example, the blog could receive the selected shipping-method from, for example, system 114 via network 100. The selected shipping-method could then be stored within a webpage or document that is accessible via the blog. In another specific example, media distribution center 120 could have a short message service server that can broadcast the selected shipping-method to users in a text message. In another specific example, media distribution center 120 could include an email server that is configured to generate emails that include the selected shipping-method and send them to users. In yet another specific example, media distribution center 120 could disseminate the selected shipping-method over a radio signal, e.g., a radio station, via a news letter, and/or via television.

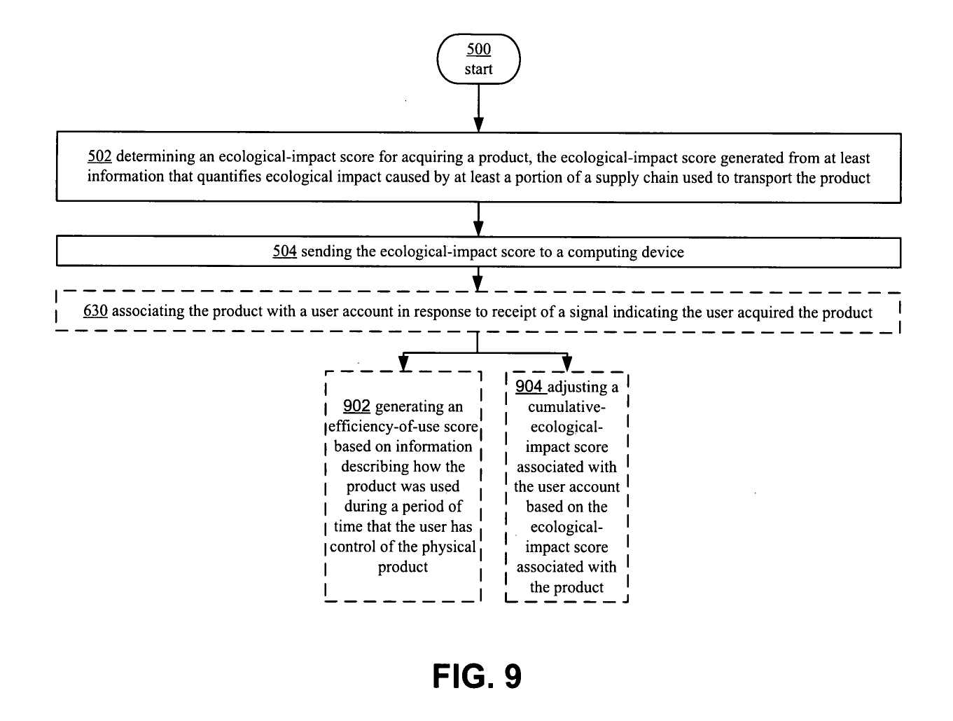

Turning now to FIG. 9, it illustrates additional operations 902 and 904 that can be executed in conjunction with those depicted by FIG. 5. Turning to operation 902, it shows generating an efficiency-of-use score based on information describing how the product was used during a period of time that the user has control of the physical product. Turning again back to FIG. 2, an efficiency-of-use score can be generated, e.g., calculated, from information that described how product 102 was used during a period of time that user 300 has or had control of product 102 by ecological-impact circuitry 206. For example, association circuitry 254 can cause ecological-impact circuitry 206 to generate, e.g., compute, an efficiency-of-use score for the use of product 102 when user disposes of product 102 and dissociates product 102 from user account 252 or at predetermined intervals.

For example, networking circuitry 116 of system 114 can receive information that describes how product 102 was used during the period of time that the user had control of it; such as for example, information that describes the status of product 102 or a portion of product 102, information that describes if product 102 was damaged, information that describes how much product 102 depleted, i.e., used-up, etc. This information can be routed to ecological-impact circuitry 206, which can use it to compute an efficiency-of-use score, e.g., a numerical value such as 1 to 100 where lower numbers indicate a more efficient use, a score such as “good,” “bad,” “average,” or a score such as A, B, C, D, or F, from the information and an efficiency-of-use profile for product 102 stored in product profile database 210. For example, a profile for product 102 can be stored in product profile database 210 that can define the ideal-efficient use of product 102. The information that describes how product 102 was used can be compared to the use-profile and the score can be calculated. The use-profile for product 102 could then be updated to reflect its current status in the instance that product 102 is depleted (or partially depleted) during the use.

In a specific example, suppose user 300 purchases product 102, which could be a chainsaw. In this example, user 300 may control product 102 a significantly long period of time, e.g., 1 year, 5, years, 10 years, etc. In this example, an efficiency-of-use score could be computed each time user 300 uses the chainsaw, at the end of each day, week, month, etc.

Continuing with the description of FIG. 9, operation 904 shows adjusting a cumulative-ecological-impact score associated with the user account based on the ecological-impact score associated with the product. For example, and referring again to FIG. 2, ecological-impact circuitry 206 can compute an efficiency-of-use score for the use of product 102 (the score could be for a portion of the time that user 300 controls product 102 or for the entire time user 300 controls product 102) and use it to update a cumulative-efficiency-of-use score stored in the user account for user 300. For example, the cumulative-efficiency-of-use score could be a score that captures how efficient user 300 uses a plurality of products, e.g., all or a portion of the products he or she owns, rents, borrows, etc. In a specific example, the cumulative-efficiency-of-use score could be computed from efficiency-of-use scores associated with TVs, refrigerators, automobiles, cellular phones, clothing, shoes, etc. In this exemplary embodiment, each efficiency-of-use score can be weighted in order to combine it with other scores. In this way, the efficiency-of-use score for using an automobile can be combined with an efficiency-of-use score with a TV.

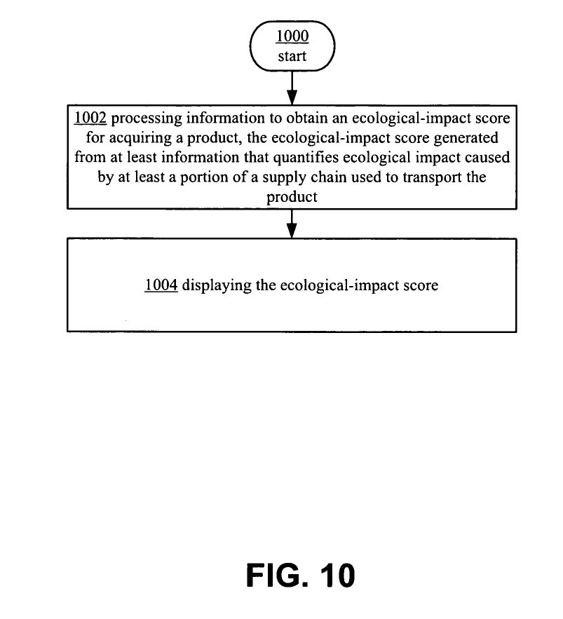

Turning now to FIG. 10, it illustrates an operational procedure for practicing aspects of the present disclosure including operations 1000, 1002, and 1004. Referring to operation 1000, it begins the operational procedure and operation 1002 shows processing information to obtain an ecological-impact score for acquiring a product, the ecological-impact score generated from at least information that quantifies ecological impact caused by at least a portion of a supply chain used to transport the product. For example, and referring to FIG. 4, in an embodiment device 302 can process data, e.g., execute operations on data, in order to obtain an ecological-impact score for acquiring a product, such as product 102. For example, device 302, which could be a mobile device, a laptop computer, a tablet computer system, a desktop PC, etc., could receive an ecological-impact score and process it, e.g., execute operations on the ecological-impact score such as extracting it from a packet of data, or alternatively device 302 could determine an ecological-impact score by processing data, e.g., generating an ecological-impact score from information such as information that describes at least a part of a supply chain used to transport product 102.

Similar to the subject matter described in previous paragraphs, an ecological-impact score can be generated from at least information that quantifies ecological impact caused by at least a portion of a supply chain used to transport the product 102. For example, and referring to FIG. 1, a product can take a variety of paths from the place that it is manufactured until it is delivered to an acquiring entity and the ecological-impact caused by the infrastructure used to move product 102 can be obtained and stored in supply chain database circuitry 204 of FIG. 2 and/or client-supply-chain database circuitry 402. The information can then be used to generate an ecological-impact score that covers the entire supply chain, e.g., from the act of gathering raw and manufactured materials until product 102 is disposed of, or it could cover a portion of the supply chain, e.g., the ecological impact due to transporting product 102 from a warehouse associated with the manufacturer to a distribution center.

Suppose in a specific example product 102 is a pair of sunglasses and the ecological-impact score is associated with the portion of the supply chain used to transport the sunglasses from a location associated with the manufacturer location 104 to a product retailer location 112. As such, when an acquiring entity enters product retail location 112 he or she could check the price tag for the sunglasses and see an ecological-impact score that covers the aforementioned portion of the supply chain. In this example, information that describes how the sunglasses were transported from manufacturer location 104 to product retail location 112 could have been sent to system 114, which could be controlled by an entity that also controls manufacturer location 104 or it could be a separate entity.

Turning again to FIG. 10, operation 1004 shows displaying the ecological-impact score. For example, device 302 can display the ecological-impact score on, for example, an LCD screen of user interface circuitry 412. In a specific example, suppose that device 302 is rendering a web-page that displays product 102. In this example, the information associated with product 102 in this example could include the ecological-impact score for at least a part of the supply chain used to transport product 102. Referring briefly to FIG. 1, the webpage in one configuration could be controlled by product supplier web-server 118, which could be a company that operates retail locations, wholesaler locations, regional distribution centers, etc. In this example, product supplier web-server 118 may have obtained the ecological-impact score for product 102 from system 114. For example, an entity that controls system 114 may setup an interface so that supplier web-server 118 can access system 114 to retrieve ecological-impact scores. The ecological-impact score for product 102 for at least a part of the supply chain can then be embedded within a webpage that can be sent to device 302.

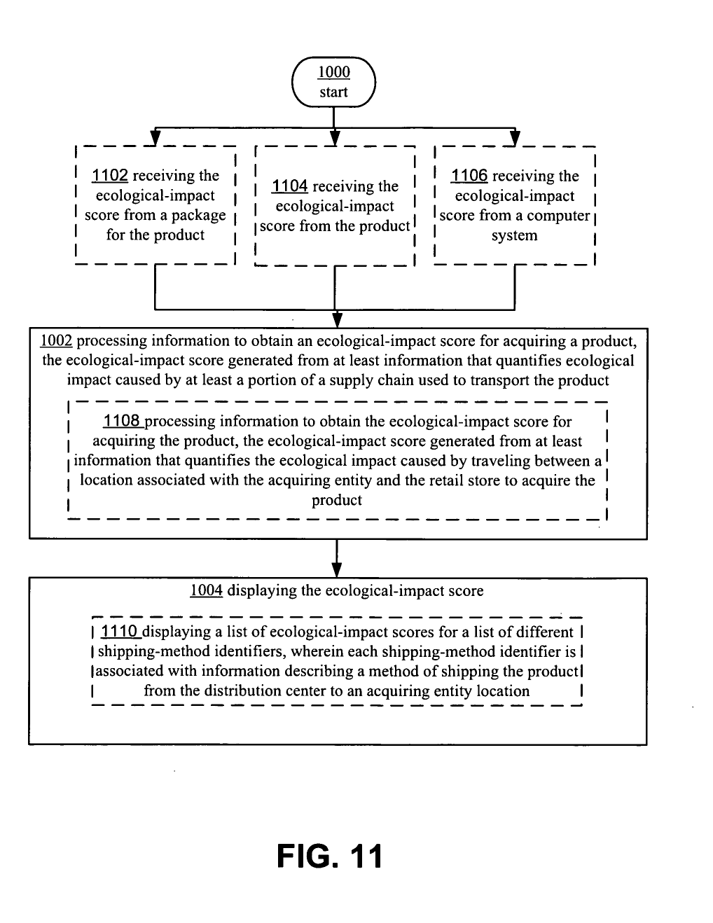

Referring now to FIG. 11, it illustrates additional operations 1102-1110 that can be executed in conjunction with those illustrated by FIG. 11. Turning to operation 1102, it shows receiving the ecological-impact score from a package for the product. For example, and referring to FIG. 3, in this example, a package for product 102 can communicate information indicating the ecological-impact score to device 302, which could be a mobile device 302 in a specific example. For example, the ecological-impact score 304 could be stored in a memory, an RFID tag, printed on a tag, etched into product package 306, etc. Turning to FIG. 4, device 302 can use camera module 404, barcode reader module 406, RFID reader module 410, etc., to extract the ecological-impact score for at least a part of the supply chain used to transport product 102. Data indicative of the ecological-impact score can be received by device 302 and processed to obtain the ecological-impact score.

Continuing with the description of FIG. 11, operation 1104 shows receiving the ecological-impact score from the product. For example, in an embodiment product 102 can communicate information indicating the ecological-impact score to device 302, which could be a mobile device 302 in a specific example. For example, the ecological-impact score 310 could be stored in a memory, an RFID tag, printed on a tag, etched into product 102, etc. Turning to FIG. 4, device 302 can use camera module 404, barcode reader module 406, RFID reader module 410, etc., to extract the ecological-impact score for at least a part of the supply chain used to transport product 102. Data indicative of the ecological-impact score can be received by device 302 and processed to obtain the ecological-impact score.

Continuing with the description of FIG. 11, operation 1106 shows receiving the ecological-impact score from a computer system. For example, in an embodiment, device 302 can receive the ecological-impact score from a computer system within system 114. For example, device 302 could have sent a request for the ecological-impact score to system 114 via networking circuitry 422. System 114 could have received the message and routed it to ecological impact module 206, which could have computed the ecological-impact score and sent it to device 302. Networking circuitry 422 can be a wireless radio system or a communication circuit that uses a cable such as a USB or Ethernet cable to connect to a network such as network 100. In a specific example where network circuitry 422 is a wireless radio system, the wireless radio system can be configured to use one of a plurality of wireless protocols to communicate with network 100. For example, the wireless adaptor could be configured to communicate with a Wi-Fi network, a WiMax network, a wireless personal area network, e.g., a network that exchanges signals that are compliant with the Institute of Electrical and Electronics Engineers (IEEE) 802.15 standard, a mobile phone network such as a Code Division Multiple Access (CDMA) or a Global System for Mobile Communications (GSM) based mobile network. In another specific example, the wireless network adaptor could be a point-to-point communication based system. For example, the network adaptor could communicate the information using the Bluetooth® standard, a near-field communication standard, e.g., a European Computer Manufacturers Association (ECMA) standard number 340 or International Organization for Standardization number 1444e, or the Zigbee standard.

Returning briefly to FIG. 11, operation 1108 shows processing information to obtain the ecological-impact score for acquiring the product, the ecological-impact score generated from at least information that quantifies the ecological impact caused by traveling between a location associated with the acquiring entity and the retail store to acquire the product. For example, an ecological-impact score can be calculated that reflects ecological harm caused by a user that travels to retail location 112 to acquire product 102.

In an example embodiment, user 300 may acquire product 102 from retail location 112 or wholesaler location 110. In this example, the last leg can be computed from information captured by an employee of retail location 112 or wholesaler location 110. The information can describe the transportation method, e.g., the number of miles traveled, time traveling, speed, vehicle type, etc. System 114 can receive the information and access supply chain database 210 to look up the transportation mode used by user 300, e.g., bus, car, bike, etc., and use information such as the number of miles drive, average speed, time spent traveling, etc., to compute an ecological-impact score for this leg.

In another configuration, suppose device 302 is a mobile device and includes device location determination circuitry 408, e.g., a GPS receiver. In this example, the GPS receive could be activated and can track the path used by user 300 to go to product retail location 112. When user 300 purchase product 102 he or she can use user interface circuitry 412, e.g., a touch display, to input information that indicates that user 300 has acquired product 102 and the transportation mode used to get to product retailer 102. System 114 can receive the information and access supply chain database 210 to look up the transportation mode used by user 300, e.g., bus, car, bike, etc., and use the distance information to compute an ecological-impact score for this leg of the journey.

In another embodiment, product 102 can be acquired through supplier web-server 118. In this example, the last leg can be calculated based on a selection of a shipping method by the acquiring entity and, for example, the distance needed to travel to deliver product. In this example, system 114 and ecological-impact circuitry 206 can access supply chain database 210 to look up the shipping-method or modes for product 102 to obtain an ecological-impact score.

Returning briefly to FIG. 11, operation 1110 shows displaying a list of ecological-impact scores for a list of different shipping-method identifiers, wherein each shipping-method identifier is associated with information describing a method of shipping the product from the distribution center to an acquiring entity location. For example, ecological-impact circuitry 206 can receive a request to generate one or more ecological-impact scores: one for a different shipping-method that is available to ship product 102 to acquiring entity location 108. For example, suppose that next day air method, a second-day air method, and a ground method are available for product 102.

In response to receipt of a request, ecological-impact circuitry 206 can extract the shipping-method identifiers and submit a query to supply chain database circuitry 204 that identifies the company offering product 102, the address of acquiring entity location 108, the identity of the product, etc. Supply chain database circuitry can search shipping infrastructure table 210 to determine a list of possible shipping method and the ecological-impact caused by each shipping method. The list can be returned to ecological-impact circuitry 206, which can use size/weight information to determine one or more ecological-impact scores for product 102; each ecological-impact score can be associated with a different shipping-method that is available. Ecological-impact circuitry 206 can generate a message including the ecological-impact score and send it to a network identifier associated with a requesting computer system, e.g., supplier web-server 118, device 302, a computer system located at retail location 112, etc.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A computer implemented method, comprising:
determining an ecological-impact score for acquiring a product, the ecological-impact score generated from at least information that quantifies ecological impact caused by at least a portion of a supply chain used to transport the product; and
sending the ecological-impact score to a computing device.

2. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score in response to receipt of a device-readable indicator for the product.

3. The computer implemented method of claim 1, wherein sending the ecological-impact score to a computing device further comprises:
sending the ecological-impact score to a computer system associated with a company offering the product.

4. The computer implemented method of claim 1, wherein sending the ecological-impact score to a computing device further comprises:
sending the ecological-impact score to a computer system associated with a manufacturer of the product.

5. The computer implemented method of claim 1, wherein sending the ecological-impact score to a computing device further comprises:
sending the ecological-impact score to a device associated with an acquiring entity.

6. The computer implemented method of claim 1, wherein sending the ecological-impact score to a computing device further comprises:
sending the ecological-impact score to the product.

7. The computer implemented method of claim 1, further comprising:
associating a disposal-mode identifier describing a mode of disposing of the product with the product.

8. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from information that quantifies the ecological impact caused by manufacturing the product.

9. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by shipping the product from a manufacturing location to a wholesaler location.

10. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by shipping the product from a wholesaler location to a retail location.

11. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by shipping the product to a distribution center.

12. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by shipping the product from a manufacturer location to a retail location.

13. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by shipping the product from a distribution location to a retail location.

14. The computer implemented method of claim 1, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by shipping the product from a distribution location to a wholesaler location.

15. The computer implemented method of claim 1, further comprising:
receiving a request to determine an ecological-impact score, the request identifying a transportation method selected by an acquiring entity.

16. The computer implemented method of claim 15, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by traveling between a location associated with the acquiring entity and the retail store to acquire the product.

17. The computer implemented method of claim 15, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies ecological impact caused by shipping the product from a manufacturer location to an acquiring entity location.

18. The computer implemented method of claim 15, wherein determining an ecological-impact score for acquiring a product, the ecological-impact score generated from at least information that quantifies ecological impact caused by at least a portion of a supply chain used to transport the product further comprises:
determining the ecological-impact score for acquiring the product, the ecological-impact score generated from at least information that quantifies the ecological impact caused by transporting the product from a distribution center to an acquiring entity location.

19. The computer implemented method of claim 15, wherein determining the ecological-impact score for acquiring the product, the ecological-impact score generated from at least information that quantifies the ecological impact caused by transporting the product from a distribution center to an acquiring entity location further comprises:
determining the ecological-impact score for acquiring the product, the ecological-impact score generated from at least information that quantifies ecological impact caused by shipping the product by an air freight service.

20. The computer implemented method of claim 15, wherein determining the ecological-impact score for acquiring the product, the ecological-impact score generated from at least information that quantifies the ecological impact caused by transporting the product from a distribution center to an acquiring entity location further comprises:
determining the ecological-impact score for acquiring the product, the ecological-impact score generated from at least information that quantifies ecological impact caused by shipping the product by a priority shipping service.

21. The computer implemented method of claim 15, wherein determining the ecological-impact score for acquiring the product, the ecological-impact score generated from at least information that quantifies the ecological impact caused by transporting the product from a distribution center to an acquiring entity location further comprises:
determining the ecological-impact score for acquiring the product, the ecological-impact score generated from at least information that quantifies ecological impact caused by shipping the product by a train shipping service.

22. The computer implemented method of claim 15, wherein determining the ecological-impact score for acquiring the product, the ecological-impact score generated from at least information that quantifies the ecological impact caused by transporting the product from a distribution center to an acquiring entity location further comprises:
determining the ecological-impact score for acquiring the product, the ecological-impact score generated from at least information that quantifies ecological impact caused by shipping the product by a truck shipping service.

23. The computer implemented method of claim 15, wherein determining the ecological-impact score for acquiring the product, the ecological-impact score generated from at least information that quantifies the ecological impact caused by transporting the product from a distribution center to an acquiring entity location further comprises:
determining the ecological-impact score for acquiring the product, the ecological-impact score generated from at least information that quantifies ecological impact caused by shipping the product together with at least a second product in a container from the distribution center to an acquiring entity location.

24. The computer implemented method of claim 15, wherein determining the ecological-impact score for acquiring the product, the ecological-impact score generated from at least information that quantifies the ecological impact caused by transporting the product from a distribution center to an acquiring entity location further comprises:
determining the ecological-impact score for acquiring the product, the ecological-impact score generated from at least information that quantifies ecological impact caused by shipping the product via a shipping-mode that ships products purchased within a time period together within a tote bag.

25. The computer implemented method of claim 15, further comprising:
determining a list of ecological-impact scores for a list of different shipping-method identifiers, wherein each shipping-method identifier is associated with information describing a method of shipping the product to an acquiring entity location.

26. The computer implemented method of claim 25, further comprising:
causing a user account to be charged a fee in response to a selection of a shipping-mode associated with the shipping-method identifier, wherein the fee is based at least in part on ecological impact caused by the selected shipping-method.

27. The computer implemented method of claim 25, further comprising:
associating a reward with a user account based on a selection of a shipping method from the list.

28. The computer implemented method of claim 25, further comprising:
associating a penalty with a user account based on a selection of a shipping method from the list.

29. The computer implemented method of claim 25, further comprising:
causing information describing a selected shipping-method to be published.

30. The computer implemented method of claim 1, further comprising:
associating the product with a user account in response to receipt of a signal indicating the user acquired the product.

31. The computer implemented method of claim 30 that includes associating a penalty with a user account based on a selection of a shipping method from the list, further comprising:
generating an efficiency-of-use score based on information describing how the product was used during a period of time that the user has control of the physical product.

32. The computer implemented method of claim 30 that includes associating a penalty with a user account based on a selection of a shipping method from the list, further comprising, further comprising:
adjusting a cumulative-ecological-impact score associated with the user account based on the ecological-impact score associated with the product.

33. A computer implemented method, comprising:
processing information to obtain an ecological-impact score for acquiring a product, the ecological-impact score generated from at least information that quantifies ecological impact caused by at least a portion of a supply chain used to transport the product; and
displaying the ecological-impact score.

34. The computer implemented method of claim 33, further comprising:
receiving the ecological-impact score from a package for the product.

35. The computer implemented method of claim 33, further comprising:
receiving the ecological-impact score from the product.

36. The computer implemented method of claim 33, further comprising:
receiving the ecological-impact score from a computer system.

37. The computer implemented method of claim 33, wherein processing information to obtain an ecological-impact score for acquiring a product, the ecological-impact score generated from at least information that quantifies ecological impact caused by at least a portion of a supply chain used to transport the product further comprises:
processing information to obtain the ecological-impact score for acquiring the product, the ecological-impact score generated from at least information that quantifies the ecological impact caused by traveling between a location associated with the acquiring entity and the retail store to acquire the product.

38. The computer implemented method of claim 33, further comprising:
displaying a list of ecological-impact scores for a list of different shipping-method identifiers, wherein each shipping-method identifier is associated with information describing a method of shipping the product from the distribution center to an acquiring entity location.

39. A computer-readable storage medium including executable instructions stored thereon, the computer-readable storage medium comprising:
instructions for determining an ecological-impact score for acquiring a product, the ecological-impact score generated from at least information that quantifies ecological impact caused by at least a portion of a supply chain used to transport the product; and
instructions for sending the ecological-impact score to a computing device.

40. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score in response to receipt of a device-readable indicator for the product.

41. The computer-readable storage medium of claim 39, wherein the instructions for sending the ecological-impact score to a computing device further comprise:
instructions for sending the ecological-impact score to a computer system associated with a company offering the product.

42. The computer-readable storage medium of claim 39, wherein the instructions for sending the ecological-impact score to a computing device further comprise:
instructions for sending the ecological-impact score to a computer system associated with a manufacturer of the product.

43. The computer-readable storage medium of claim 39, wherein the instructions for sending the ecological-impact score to a computing device further comprise:
instructions for sending the ecological-impact score to a device associated with an acquiring entity.

44. The computer-readable storage medium of claim 39, wherein the instructions for sending the ecological-impact score to a computing device further comprise:
instructions for sending the ecological-impact score to the product.

45. The computer-readable storage medium of claim 39, further comprising:
instructions for associating a disposal-mode identifier describing a mode of disposing of the product with the product.

46. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from information that quantifies the ecological impact caused by manufacturing the product.

47. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instruction for determining the ecological-impact score for acquiring the product, the ecological-impact score generated from at least information that quantifies the ecological impact caused by shipping the product from a manufacturing location to a wholesaler location.

48. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies the ecological impact caused by shipping the product from a wholesaler location to a retail location.

49. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies the ecological impact caused by shipping the product to a distribution center.

50. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies the ecological impact caused by shipping the product from a manufacturer location to a retail location.

51. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies the ecological impact caused by shipping the product from a distribution location to a retail location.

52. The computer-readable storage medium of claim 39, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies the ecological impact caused by shipping the product from a distribution location to a wholesaler location.

53. The computer-readable storage medium of claim 39, further comprising:
instructions for receiving a request to determine an ecological-impact score, the request identifying a transportation method selected by an acquiring entity.

54. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies the ecological impact caused by traveling between a location associated with the acquiring entity and the retail store to acquire the product.

55. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies ecological impact caused by shipping the product from a manufacturer location to an acquiring entity location.

56. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies the ecological impact caused by transporting the product from a distribution center to an acquiring entity location.

57. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies ecological impact caused by shipping the product by an air freight service.

58. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies ecological impact caused by shipping the product by a priority shipping service.

59. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies ecological impact caused by shipping the product by a train shipping service.

60. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies ecological impact caused by shipping the product by a truck shipping service.

61. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies ecological impact caused by shipping the product together with at least a second product in a container from the distribution center to an acquiring entity location.

62. The computer-readable storage medium of claim 53, wherein the instructions for determining an ecological-impact score for acquiring a product, the ecological-impact score generated from at least information that quantifies ecological impact caused by at least a portion of a supply chain used to transport the product further comprise:
instructions for determining the ecological-impact score for acquiring the product, the ecological-impact score generated from at least information that quantifies ecological impact caused by shipping the product via a shipping-mode that ships products purchased within a time period together within a tote bag.

63. The computer-readable storage medium of claim 53, further comprising:
instructions for determining a list of ecological-impact scores for a list of different shipping-method identifiers, wherein each shipping-method identifier is associated with information describing a method of shipping the product to an acquiring entity location.

64. The computer-readable storage medium of claim 63, further comprising:
instructions for causing a user account to be charged a fee in response to a selection of a shipping-mode associated with the shipping-method identifier, wherein the fee is based at least in part on ecological impact caused by the selected shipping-method.

65. The computer-readable storage medium of claim 63, further comprising:
instructions for associating a reward with a user account based on a selection of a shipping method from the list.

66. The computer-readable storage medium of claim 63, further comprising:
instructions for associating a penalty with a user account based on a selection of a shipping method from the list.

67. The computer-readable storage medium of claim 63, further comprising:
instructions for Error! Reference source not found.

68. The computer-readable storage medium of claim 63, further comprising:
instructions for causing information describing a selected shipping-method to be published.

69. The computer-readable storage medium of claim 39, further comprising:
instructions for associating the product with a user account in response to receipt of a signal indicating the user acquired the product.

70. The computer-readable storage medium of claim 69, that includes the instructions for associating a penalty with a user account based on a selection of a shipping method from the list, further comprising:
instructions for generating an efficiency-of-use score based on information describing how the product was used during a period of time that the user has control of the physical product.

71. The computer-readable storage medium of claim 69, that includes the instructions for associating a penalty with a user account based on a selection of a shipping method from the list, further comprising:
instructions for adjusting a cumulative-ecological-impact score associated with the user account based on the ecological-impact score associated with the product.

72. A computer-readable storage medium including instructions stored thereon, the computer readable storage medium comprising:
instructions for processing information to obtain an ecological-impact score for acquiring a product, the ecological-impact score generated from at least information that quantifies ecological impact caused by at least a portion of a supply chain used to transport the product; and
instructions for displaying the ecological-impact score.

73. The computer-readable storage medium of claim 72, further comprising:
instructions for receiving the ecological-impact score from a package for the product.

74. The computer-readable storage medium of claim 72, further comprising:
instructions for receiving the ecological-impact score from the product.

75. The computer-readable storage medium of claim 72, further comprising:
instructions for receiving the ecological-impact score from a computer system.

76. The computer-readable storage medium of claim 72, wherein the instructions for processing information to obtain an ecological-impact score for acquiring a product, the ecological-impact score generated from at least information that quantifies ecological impact caused by at least a portion of a supply chain used to transport the product further comprise:
instructions for processing information to obtain the ecological-impact score for acquiring the product, the ecological-impact score generated from at least information that quantifies the ecological impact caused by traveling between a location associated with the acquiring entity and the retail store to acquire the product.

77. The computer-readable storage medium of claim 72, further comprising:
instructions for displaying a list of ecological-impact scores for a list of different shipping-method identifiers, wherein each shipping-method identifier is associated with information describing a method of shipping the product from the distribution center to an acquiring entity location.

78. A system comprising:
circuitry for determining an ecological-impact score for acquiring a product, the ecological-impact score generated from at least information that quantifies ecological impact caused by at least a portion of a supply chain used to transport the product; and
circuitry for sending the ecological-impact score to a computing device.

79. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score in response to receipt of a device-readable indicator for the product.

80. The system of claim 78, wherein the circuitry for sending the ecological-impact score to a computing device further comprises:
circuitry for sending the ecological-impact score to a computer system associated with a company offering the product.

81. The system of claim 78, wherein the circuitry for sending the ecological-impact score to a computing device further comprises:
circuitry for sending the ecological-impact score to a computer system associated with a manufacturer of the product.

82. The system of claim 78, wherein the circuitry for sending the ecological-impact score to a computing device further comprises:
circuitry for sending the ecological-impact score to a device associated with an acquiring entity.

83. The system of claim 78, wherein the circuitry for sending the ecological-impact score to a computing device further comprises:
circuitry for sending the ecological-impact score to the product.

84. The system of claim 78, wherein the circuitry for sending the ecological-impact score to a computing device further comprises:
circuitry for associating a disposal-mode identifier describing a mode of disposing of the product with the product.

85. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from information that quantifies the ecological impact caused by manufacturing the product.

86. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by shipping the product from a manufacturing location to a wholesaler location.

87. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by shipping the product from a wholesaler location to a retail location.

88. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by shipping the product to a distribution center.

89. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by shipping the product from a manufacturer location to a retail location.

90. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by shipping the product from a distribution location to a retail location.

91. The system of claim 78, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by shipping the product from a distribution location to a wholesaler location.

92. The system of claim 78, further comprising:
circuitry for receiving a request to determine an ecological-impact score, the request identifying a transportation method selected by an acquiring entity.

93. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by traveling between a location associated with the acquiring entity and the retail store to acquire the product.

94. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies ecological impact caused by shipping the product from a manufacturer location to an acquiring entity location.

95. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies the ecological impact caused by transporting the product from a distribution center to an acquiring entity location.

96. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies ecological impact caused by shipping the product by an air freight service.

97. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies ecological impact caused by shipping the product by a priority shipping service.

98. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies ecological impact caused by shipping the product by a train shipping service.

99. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies ecological impact caused by shipping the product by a truck shipping service.

100. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies ecological impact caused by shipping the product together with at least a second product in a container from the distribution center to an acquiring entity location.

101. The system of claim 92, wherein the circuitry for determining an ecological-impact score for acquiring a product, the ecological-impact score generated from at least information that quantifies ecological impact caused by at least a portion of a supply chain used to transport the product further comprises:
circuitry for determining the ecological-impact score for acquiring the product, the ecological-impact score generated from at least information that quantifies ecological impact caused by shipping the product via a shipping-mode that ships products purchased within a time period together within a tote bag.

102. The computer-readable storage medium of claim 92, further comprising:
circuitry for determining a list of ecological-impact scores for a list of different shipping-method identifiers, wherein each shipping-method identifier is associated with information describing a method of shipping the product to an acquiring entity location.

103. The system of claim 102, further comprising:
circuitry for causing a user account to be charged a fee in response to a selection of a shipping-mode associated with the shipping-method identifier, wherein the fee is based at least in part on ecological impact caused by the selected shipping-method.

104. The system of claim 102, further comprising:
circuitry for associating a reward with a user account based on a selection of a shipping method from the list.

105. The system of claim 102, further comprising:
circuitry for associating a penalty with a user account based on a selection of a shipping method from the list.

106. The system of claim 102, further comprising:
circuitry for Error! Reference source not found.

107. The system of claim 102, further comprising:
circuitry for causing information describing a selected shipping-method to be published.

108. The computer-readable storage medium of claim 78, further comprising:
circuitry for associating the product with a user account in response to receipt of a signal indicating the user acquired the product.

109. The system of claim 108, that includes the circuitry for associating a penalty with a user account based on a selection of a shipping method from the list, further comprising:
circuitry for generating an efficiency-of-use score based on information describing how the product was used during a period of time that the user has control of the physical product.

110. The system of claim 108, that includes the circuitry for associating a penalty with a user account based on a selection of a shipping method from the list, further comprising:
circuitry for adjusting a cumulative-ecological-impact score associated with the user account based on the ecological-impact score associated with the product.

111. A system, comprising:
circuitry for processing information to obtain an ecological-impact score for acquiring a product, the ecological-impact score generated from at least information that quantifies ecological impact caused by at least a portion of a supply chain used to transport the product; and
circuitry for displaying the ecological-impact score.

112. The system of claim 111, further comprising:
circuitry for receiving the ecological-impact score from a package for the product.

113. The system of claim 111, further comprising:
circuitry for receiving the ecological-impact score from the product.

114. The system of claim 111, further comprising:
circuitry for receiving the ecological-impact score from a computer system.

115. The system of claim 111, wherein the circuitry for processing information to obtain an ecological-impact score for acquiring a product, the ecological-impact score generated from at least information that quantifies ecological impact caused by at least a portion of a supply chain used to transport the product further comprise:
circuitry for processing information to obtain the ecological-impact score for acquiring the product, the ecological-impact score generated from at least information that quantifies the ecological impact caused by traveling between a location associated with the acquiring entity and the retail store to acquire the product.

116. The system of claim 111, further comprising:
circuitry for displaying a list of ecological-impact scores for a list of different shipping-method identifiers, wherein each shipping-method identifier is associated with information describing a method of shipping the product from the distribution center to an acquiring entity location.
